(19) United States
(12) Patent Application Publication
(10) Pub. No.: US 2009/0077153 A1
(43) Pub. Date: Mar. 19, 2009

(54) Reconfigurable arithmetic unit

(75) Inventor: Ivo J. Dobbelaere, Los Altos, CA (US)

Correspondence Address: PETER SU, 530 LYTTON AVENUE, SECOND FLOOR, PALO ALTO, CA, 94301, US

(73) Assignee: CSWITCH CORPORATION

(21) Appl. No.: 11/900,992

(22) Filed: Sep. 14, 2007

(51) Int. Cl. G06F 7/32

(52) U.S. Cl. 708/520

(57) ABSTRACT

A reconfigurable arithmetic circuit including a plurality of logical AND gates arranged in logical columns and rows, a plurality of conductors each connected to furnish input to the AND gates of a row, an array of memory cells each connected to furnish input to one of the AND gates, and a plurality of reconfigurable counting circuits, each counting circuit connected to receive the output of each of the AND gates in a column, each counting circuit being configurable to provide a count of parity of the outputs furnished by the AND gates of the column.

### BACKGROUND OF THE INVENTION

1. Field of the Invention

This invention relates to electronic circuitry and, more particularly, to reconfigurable circuitry which may be utilized to carry out a number of different logical operations on data.

2. History of the Prior Art

The manipulation of data in modern electronic systems requires the transmission of data from place to place, for example, within a local network or over the internet. The speed of data transmission has increased (and continues to increase) as various new forms of hardware are created and older forms are improved. However, no matter how rapidly data is transmitted, it is only useful if transmitted without errors.

There are a number of methods for testing to determine if data has been correctly transmitted. One of these methods makes use of what is referred to as a cyclical redundancy check (CRC) to ascertain whether data being received is what was in fact sent. Typically, at the sending station the cyclical redundancy check process adds to the data stream of a message a sequence of bits generated from that data stream then determines at the receiving station whether the message with the added bits is correct. Since the bits added at the sending station are determined by the content of the message being sent, those added bits may be tested against the message to determine (within reason) whether the message received is correct.

Historically, the cyclical redundancy check was conducted on a bit serial basis as the data was received. Such a process functions well when the bits of a message are transmitted serially and at slower speeds. However, as faster transmission speeds are attained (including those attained by parallel bit transmission) such a test requires a relatively large amount of time and significantly reduces the overall speed of message transmission. Recently, software techniques have been devised for handling portions of the operation in parallel to decrease the time required for the cyclical redundancy check. For example, a paper entitled Fast Parallel CRC Algorithm and Implementation on a Configurable Processor, Ji and Killian, ICC2002-IEEE International Conference on Communications, vol. 25, no. 1, April 2002, pp. 1813-17, demonstrates an operation by which a cyclical redundancy check is accomplished on a message of indeterminate length by testing message portions of consistent segment lengths and then combining the results of the tests on the message portions.

Although such techniques have decreased the time required for the cyclical redundancy check, even more transmission speed can be attained by a hardware solution. However, once chip area is allocated to a hardware solution, the circuitry is typically useful for accomplishing only the limited purposes for which it was devised.

To this end, it is desirable to enhance the speed of data transmission by hardware techniques which may be utilized to carry out a large variety of different logical operations on data.

### SUMMARY OF THE INVENTION

It is an object of the present invention to enhance the speed of data transmission by providing circuitry which may be utilized for a variety of purposes including providing and testing the correctness of cyclical redundancy check values.

The present invention is realized by a reconfigurable arithmetic circuit including a plurality of logical AND gates arranged in logical columns and rows, a plurality of conductors each connected to furnish input to the AND gates of a row, an array of memory cells each connected to furnish input to one of the AND gates, and a plurality of reconfigurable counting circuits, each counting circuit connected to receive the output of each of the AND gates in a column, each counting circuit being configurable to provide a count of parity of the outputs furnished by the AND gates of the column.

These and other objects and features of the invention will be better understood by reference to the detailed description which follows taken together with the drawings in which like elements are referred to by like designations throughout the several views. It is to be understood that, in some instances, various details of the invention may be shown exaggerated or otherwise modified to facilitate an understanding of the invention. Moreover, some aspects of the invention considered to be conventional may not be shown so as to avoid obfuscating more important aspects or features of the invention.

### BRIEF DESCRIPTION OF THE DRAWINGS

FIG. 1 is a block diagram illustrating the logical structure of a reconfigurable arithmetic unit constructed in accordance with the present invention;

FIGS. 2A and 2B are tables listing Galois field values for scaling of a thirty-two bit message portion by a fixed polynomial x³² mod G(x) and x⁶⁴ mod G(x), respectively, for the standard Ethernet CRC polynomial G(x);

FIG. 3A is a block diagram illustrating a portion of a logic tree which may be utilized in the reconfigurable arithmetic unit of FIG. 1;

FIG. 3B is a block diagram of a reconfigurable logic tree which may perform the functions of the logic tree of FIG. 3A.

FIG. 4 is a block diagram illustrating circuitry for utilizing a plurality of the reconfigurable arithmetic units of FIG. 1;

FIG. 5 illustrates another embodiment of a reconfigurable arithmetic unit constructed in accordance with the present invention;

FIG. 6 illustrates the use of a reconfigurable arithmetic unit to accomplish general Galois field multiplication;

FIGS. 7A, 7B, and 7C are block diagrams illustrating reconfigurable circuitry for providing either NXOR or AND operations for the logic tree of FIG. 3B;

FIGS. 8A and 8B are diagrams illustrating switchbox arrangements useful in the arrangement of FIG. 4;

FIGS. 9A, 9B, and 9C illustrate details of the arrangements of FIGS. 8A and 8B.

FIGS. 10A and 10B are block diagrams illustrating the use of the invention for rotating and shifting values, respectively;

FIGS. 11A and 11B are block diagrams illustrating the use of the invention as a lookup table in two embodiments;

FIG. 12 is a block diagram illustrating the use of the invention for providing content addressable memory;

FIG. 13 illustrates slices of a systolic array for the Berlekamp-Massey algorithm portion of a Reed-Solomon decoder;

FIGS. 14A, 14B, and 14C together form a block diagram illustrating an arrangement for performing a cyclical redundancy check for a message of a length greater than that handled by an individual reconfigurable arithmetic unit;

FIG. 15 is another embodiment of a switchbox arrangement useful in the arrangement of FIG. 4; and

FIG. 16 illustrates how a section of a slice of the systolic array shown in FIG. 13 may be mapped onto the Galois field fabric of FIG. 4.

### DETAILED DESCRIPTION

As has been pointed out, a cyclical redundancy check is used to determine that data which has been received is the data which was, in fact, sent. A cyclical redundancy check usually appends a sequence of bits to the data stream of a message at the sending station then determines whether the message including the appended bits is correct at the receiving station. The appended bits are generated at the sending station based on the message being sent. Consequently, the appended bits may be tested against the message received to determine (within reason) whether it is correct.

A cyclical redundancy check may be utilized in a great many aspects of data transmission. It may be used to determine that data sent over the internet or other communications has been correctly received. It may be used for the same purpose in local area networks. It may be used to determine within a specific piece of data manipulation hardware (such as a computer) whether data is correctly transmitted and received by the different components of that piece of hardware.

Because a cyclical redundancy check may be (and often is) used in so many aspects of data transmission, the speed with which the check takes place necessarily affects the speed at which data may be transmitted. Classically, the operations of generating and later testing a cyclical redundancy value appended to serially transmitted data were accomplished a bit at a time as the data was transferred. As data transmission speed has increased by improvements such as increasing the width of the data path, such a method has become much too time consuming.

Consequently, methods have been devised for generating and testing a cyclical redundancy value while handling bit portions of the transmitted data in parallel. Typically, these methods are accomplished by executing a specified algorithm on a processor to manipulate the data to generate or check a cyclical redundancy value.

As with many elements of data manipulation, a hardware solution can provide results faster than can a software solution. However, a hardware solution is typically not as flexible as a software solution.

The present invention offers a hardware solution to the operations of obtaining and checking cyclical redundancy values which solution overcomes the limitations of prior art solutions. More particularly, the hardware of the present invention is uniquely reconfigurable so that it may be used for a variety of different forms of cyclical redundancy check computations and may be converted to accomplish a plurality of other logical functions as well.

In order to understand the invention, it will be useful to understand how a cyclical redundancy check is carried out. First, an introduction to the Galois field framework is useful.

The cyclical redundancy check of concern is implemented utilizing Galois field arithmetic in an extension field GF(2^{N}) of the finite field referred to as GF(2). In GF(2), which has elements that can be represent by single binary digits, the addition operation is a modulo 2 addition which is equivalent to an exclusive OR (XOR) operation, and the multiplication operation is equivalent to an AND operation. Because of these equivalences, Galois field arithmetic is useful in implementing data operations. Elements of the extension field GF(2^{N}) may be represented as single-digit binary coefficients of a polynomial in x of degree-bound N, or as a binary number of N digits. The addition operation in GF(2^{N}) is obtained by performing the addition in GF(2) on the coefficients of equal power of x, in the polynomial representation, or as a bit-wise XOR, in the binary number representation.

In order to define multiplication in GF(2^{N}), a primitive polynomial G(x) must be selected. This primitive polynomial G(x) is a polynomial of degree N that is prime (i.e., it can not be factored into smaller polynomials) and that has at least one zero that is a generator of the field GF(2^{N}). A generator of GF(2^{N}) is an element that, when raised to the powers 1 through 2^{N} sequentially, will cycle through each non-zero element of GF(2^{N}) exactly once [see Fast CRC Calculation, R. J. Glaise and X. Jacquart, Proceedings of the IEEE International Conference on Computer Design: VLSI in Computers, pp. 602-605, 1993. (IBM)]. In GF(2^{N}) with primitive polynomial G(x), any intermediate result R(x) that has a polynomial representation of degree N or higher must be folded back into a polynomial of degree-bound N by calculating its value modulo G(x) (further referred to as mod G(x)), which is obtained by performing a polynomial division of R(x) by G(x) and determining the remainder. In order to calculate the multiplication of two elements A(x) and B(x) of GF(2^{N}), the raw polynomial multiplication C(x), which is of degree-bound 2N, is first calculated; and then the remainder R(x)=C(x) mod G(x) is calculated.

In its simplest form, the basic operation of a cyclical redundancy check transmitter is to extend the message data with a number of zeroes matching the order of the primitive polynomial as the least significant bits; and then, while treating the obtained value as a polynomial with binary coefficients, determine the modulo G(x) remainder (which is the CRC value), and replace the padded zeroes by this CRC value in the data that is being transmitted. The data is transmitted most-significant-bit first, so the CRC value follows after the original message has been transmitted. The result is a data stream having a value which is an exact multiple of the primitive polynomial. When the data is received, the data including the CRC value in polynomial representation is divided by the same primitive polynomial used in generation of the CRC value. If the remainder of this division is zero, it is highly probable that the data has been transmitted and received correctly. The hardware required for implementing the CRC transmitter and receiver is largely identical.

It should be noted that in this scheme, the same primitive polynomial is used to accomplish the division both in generating and in testing the cyclical redundancy check value. Thus, the value used for the division need not be part of the information transferred with a message.

The polynomial division modulo G(x) can easily be serialized; and, in fact, the first methods for accomplishing a cyclical redundancy check using Galois field arithmetic operated serially upon the sequential bits of a message (and the message with an appended cyclical redundancy check value). As has been pointed out, such an operation functions well for sequentially transmitted messages but slows faster transmission methods. Consequently, methods for handling sequences of bits in parallel have been devised. Typically, the methods involve selecting from a message bit portions or segments having a common bit width, treating those segments individually to modulo G(x) division by means of software executing on a processor, and combining the results to complete the cyclical redundancy check for any message being transmitted whatever its data width. Examples of such methods are illustrated in Fast Parallel CRC Algorithm and Implementation on a Configurable Processor, H. M. Ji and E. Killian, ICC2002—IEEE International Conference on Communications, vol. 25, no. 1, April 2002, pp. 1813-1817.

The present invention is primarily concerned with calculating the CRC value serially on message portions that have a length that is a multiple of the size of the primitive polynomial G(x). The following discussion details how this can be achieved. The Galois field operations can be efficiently implemented according to the present invention.

Assume now a message M consisting of L binary values, where L is very large (L>>N). This message can be represented by a polynomial M(x) of degree-bound L.

To illustrate this, consider the Galois field GF(2³²) defined by the primitive polynomial:

G(x)=x³²+x²⁶+x²³+x²²+x¹⁶+x¹²+x¹¹+x¹⁰+x⁸+x⁷+x⁵+x⁴+x²+x¹+x⁰ [Eq. 1]

as defined for use in The Ethernet, A Local Area Network, Data Link Layer and Physical Layer Specifications, Digital Equipment Corporation, Intel Corporation and Xerox Corporation, Stamford, Conn., Version 1.0. Sep. 30, 1980, page 22.

Although this example utilizes N=32 and treats CRC32 using the example polynomial, the results are intended for the general case.

Elements of GF(2³²) can be represented as binary thirty-two bit vectors, e.g., A[31:0], B[31:0] or as the equivalent polynomials in GF(2³²) as follows:

A(x)=A[31] x³¹+ . . . +A[1] x¹+A[0] x⁰ [Eq. 2]

B(x)=B[31] x³¹+ . . . +B[1] x¹+B[0] x⁰ [Eq. 3]

Similarly, G(x) has a corresponding thirty-three bit binary value:

G[32:0]=1 00000100 11000001 00011101 10110111 [Eq. 4]

### Galois Field Scaling

A polynomial A(x) can be multiplied by a polynomial B(x) for the case where B(x) is fixed. This is also referred to as Galois field scaling.

To scale A[31:0] by B[31:0] in GF(2³²) defined by G(x) is equivalent to finding:

R(x)=(A(x)*B(x)) mod G(x) [Eq. 5]

where mod G(x) is the modulo G(x) operation, or the remainder of the operand after polynomial division by G(x) in GF(2³²).

The following derivation relies on properties of the modulo G(x) operator:

(A(x)+B(x)) mod G(x)=A(x) mod G(x)+B(x) mod G(x)

and, for a polynomial A(x) of order 31 or less:

(A(x)*B(x)) mod G(x)=A(x)*(B(x) mod G(x))) modG(x).

Equation 5 can be rewritten as:

$$\begin{matrix}R ( x ) = \{ \{ A [ 31 ] {x}^{31} … A [ 1 ] {x}^{1} + A [ 0 ] {x}^{0} \} * B ( x ) \} mod G ( x ) \\ = \{ A [ 0 ] * ( {x}^{0} * B ( x ) ) mod G ( x ) \} + \\ \{ A [ 1 ] * ( {x}^{1} * B ( x ) ) mod G ( x ) \} … + \\ \{ A [ 31 ] * ( {x}^{31} * B ( x ) ) mod G ( x ) \}\end{matrix} \qquad \begin{matrix}[ Eq . 6 ] \\ \\ \\ [ Eq . 7 ]\end{matrix}$$

Which in turn equals:

=A[0]*F[0](x)

+A[1]*F[1](x) . . .

+A[31]*F[31](x) [Eq. 8]

Or:

=F(x)*A(x) [Eq. 9]

where F(x) is a vector of polynomials [F[0](x) . . . F[31](x)], and where each F[i](x)=(xⁱ*B(x)) mod G(x). In other words, F[i](x) is the remainder of the polynomial division of xⁱ*B(x) by G(x). In recursive form this yields:

F[i](x)=(x*F[i-1](x)) mod G(x) [Eq. 10]

Since F[i−1](x) mod G(x)=F[i−1](x), x*F[i−1](x) can only be of order 32, in which case a simple XOR of x*F[i−1](x) with G(x) suffices to calculate the mod G(x) remainder.

Hence, a recursive method to pre-calculate the coefficients F[i][31:0] of F[i](x) is as follows:

```
F[0][31:0] = B[31:0]
for i in range 1 to 31 with increments of 1:
    if (F[i−1][31] == 0) then:
        F[i][31:1] = F[i−1][30:0]
        F[i][0] = 0
    else:
        F[i][31:1] = XOR(F[i−1][30:0], G[31:1])
F[i][0]= XOR( 0, G[0] )
```

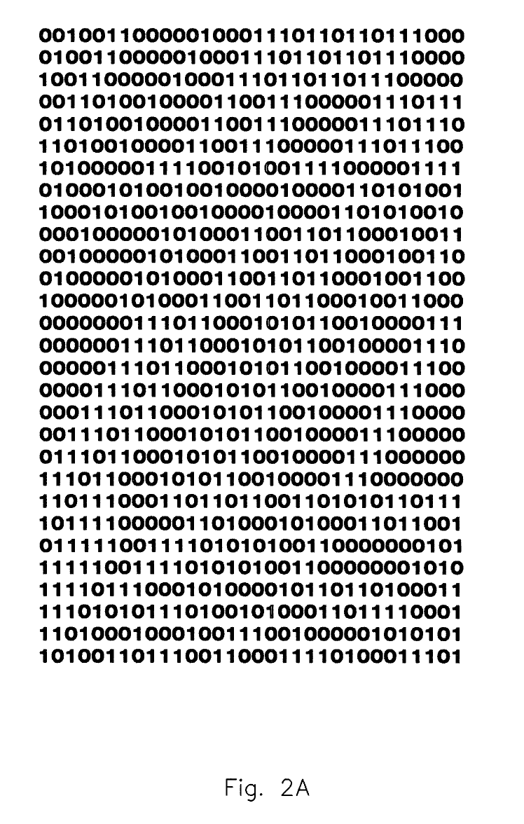

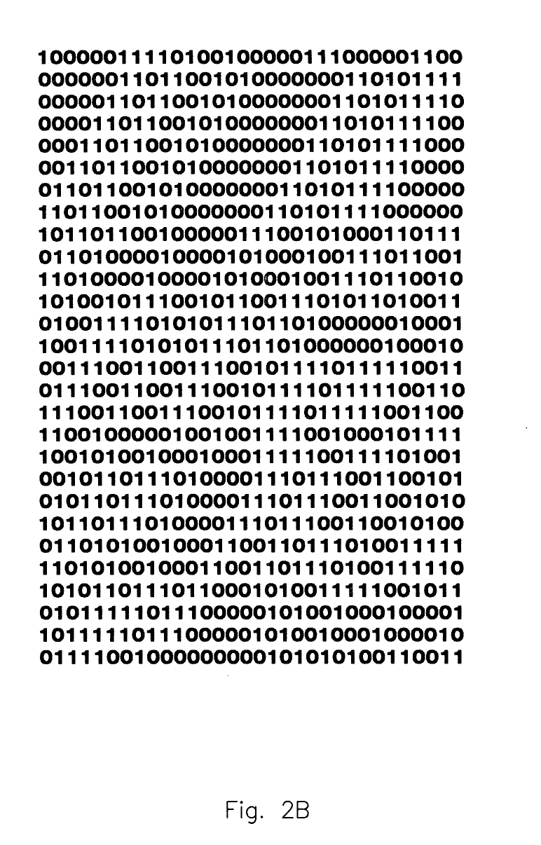

For each vector F[i][31:0], this describes a left shift of F[i−1][31:0], with conditional XOR with the coefficients of the primitive polynomial G(x) if F[i−1][31] is 1. An example of values for the matrix F[31:0][31:0] for scaling by B(x)=x³² for the primitive polynomial G(x) of [Equation 1], obtained using this method, is shown in FIG. 2a. Once the matrix F[31:0][31:0] is found, the scaling of A[31:0] is obtained as follows:

R[i]=F[i][0]*A[0]+F[i][1] *A[1] . . . F[i][31] *A[31] [Eq. 11]

where in this case “*” is AND and “+” is XOR according to GF(2) arithmetic.

Hence, the result R[31:0] of scaling of a variable A[31:0] by a constant in the Galois field GF(2³²) can be obtained as thirty-two wide XOR operations on different subsets of elements of the variable A[31:0], where inclusion in a particular XOR operation is predetermined. Such a calculation can be performed using a structure according to the present invention.

### Cyclical Redundancy Check Using Galois Field Scaling

“Designing TCP/IP Functions in FPGAs”, W. Lu, MSc Thesis, Delft, The Netherlands, August 2003, pp. 34-38, shows how scaling in GF(2³²) can be used for cyclical redundancy check, in the case of thirty-two bit message segments. Let A(x) be a new message segment of thirty-two bits, and part of a larger message M(x). Let CRCPrev(x) be the CRC calculated for portion P(x) of the message M(x) up to but not including A(x), then:

CRCPrev(x)=x³² P(x) mod G(x) [Eq. 12]

Let CRCNew(x) be the CRC calculated for the portion of the message M(x) up to and including A(x):

CRCNew(x)=x³² (x³² P(x)+A(x)) mod G(x) [Eq. 13]

This can be rewritten in recursive format, using the earlier mentioned properties of mod G(x), as:

CRCNew(x)=((CRCPrev(x)+A(x)) x³²) mod G(x) [Eq. 14]

Equation 14 shows that a CRC can be calculated iteratively using bitwise XOR followed by Galois field scaling.

Next, this result is combined with the derivation from Fast Parallel CRC Algorithm and Implementation on a Configurable Processor, referred to above, to show how to calculate the CRC value iteratively, using scaling, on message portions that have lengths that are a multiple of the order of the primitive polynomial. For example, let A(x) be a sixty-four bit message portion, consisting of two thirty-two bit portions A0(x) and A1(x) such that:

A(x)=x³² A1(x)+A0(x) [Eq. 17]

Meaning that A1(x) is the first arriving thirty-two bit portion.

Then, keeping the same notation as before:

$$\begin{matrix}CRCNew ( x ) = {x}^{32} ( {x}^{64} P ( x ) + A ( x ) ) mod G ( x ) \\ = ( {x}^{32} ( {x}^{64} P ( x ) + {x}^{32} A 1 ( x ) + A 0 ( x ) ) ) mod G ( x ) \\ = ( {x}^{64} * ( {x}^{32} P ( x ) + A 1 ( x ) ) ) mod G ( x ) + ( {x}^{32} * A 0 ( x ) ) mod G ( x ) \\ = ( {x}^{64} * ( CRCPrev ( x ) + A 1 ( x ) ) ) mod G ( x ) + ( {x}^{32} * A 0 ( x ) ) mod G ( x ) .\end{matrix} \qquad \begin{matrix}[ Eq . 18 ] \\ [ Eq . 19 ] \\ [ Eq . 20 ] \\ [ Eq . 21 ]\end{matrix}$$

This shows that the thirty-two bit CRC value can be obtained iteratively for sixty-four bit wide message chunks, using bit-wise XOR and GF scaling by either x³² mod G(x) or by x⁶⁴ mod G(x). The matrices F containing values corresponding to these scaling amounts can be predetermined. If stored, these values are immediately available to accomplish Galois field operations at both the transmission and reception of a message. This greatly enhances the speed of the division operation. FIGS. 2A and 2B show these values for scaling by x³² mod G(x) or by x⁶⁴ mod G(x), respectively, for Ethernet CRC.

Concatenating a message by the remainder from modulo G(x) division provides a message value which has a remainder of zero when again divided by the same divisor. Consequently, a remainder of zero from the second division, performed at the receiver, suggests that the data has been correctly transmitted.

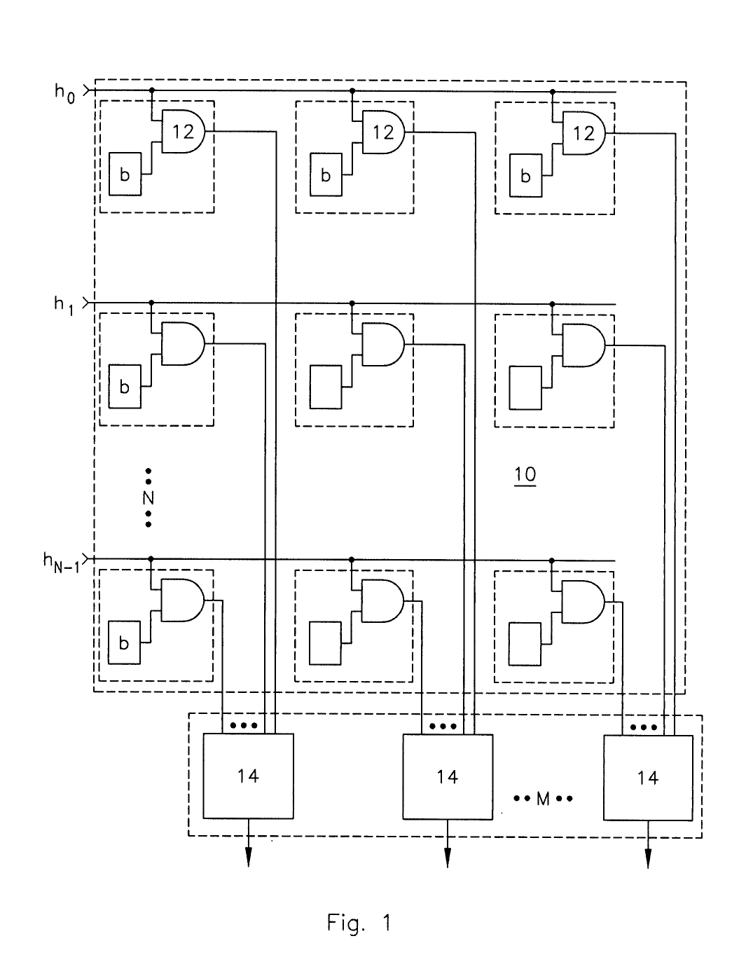

The present invention provides a hardware solution which produces more rapid results than the software solution of the prior art and which may be reconfigured to allow a number of distinct logical operations in addition to cyclical redundancy check scaling of different types. FIG. 1 is a block diagram illustrating a basic reconfigurable arithmetic unit 10.

The arithmetic unit 10 includes a plurality of AND gates 12 logically arranged in rows and columns. In this description, “logical arrangement” means that the circuitry functions as though the devices were physically arranged in the manner illustrated even though the individual elements may be physically positioned differently. In the basic embodiment, each row and each column of the arithmetic unit 10 includes a number of AND gates 12. The number of AND gates in a column of a basic unit may be approximately equal to a convenient number of bits of a typical input message (i.e., hₒ-h₃₁). That is, if an input message typically may be divided into groups each of which includes thirty-two bits, then each column of the arithmetic unit 10 has thirty-two AND gates. On the other hand, although the number of AND gates in each row of the arithmetic unit 10 may also be thirty-two, this number is selected based on the largest polynomial to be used in the cyclical redundancy check. Moreover, depending on the actual details of the mathematical operations being conducted, a larger or smaller number of AND gates 12 might be utilized in each row and column; and extra AND gates 12 might be added to each row or column for purposes such as a parity check.

In the arithmetic unit 10, each AND gate 12 in a row receives the same bit of the message as an input. Each AND gate 12 in a column receives a logically sequentially increasing (or decreasing) bit of the message as an input. Each AND gate 12 in a column also receives a second value (referred to as a ∂parity masking bit”) which is a logically sequentially increasing (or decreasing) bit of a Galois field value. The Galois field values furnished to the AND gates 12 of each sequential column of the arithmetic unit 10 are the sequential Galois field values computed for the particular message length. For Galois field scaling as described above, these values are typically constants which may be precomputed and stored for ready use in parity mask memory cells associated with the AND gates 12. For a thirty-two bit message portion, the associated Galois field scaling M(x) multiplied by (x³²) mod G(x) can be obtained by using as parity mask memory values the values shown in the table of FIG. 2a.

It should be noted that the particular primitive polynomial for thirty-two bits is usually referred to as CRC32 and is the polynomial used in Ethernet communications selected by an industry standards committee and described in IEEE 802.3-2002, Section 3.8. The CRC32 polynomial is that presented in Equation 1, above, and represented in binary form in Equation 4 above.

As may be visualized, when a thirty-two bit message is presented to the arithmetic unit 10, the sequential bits hₒ-h₃₁ of that message appear at the input terminals of the sequentially-positioned AND gates 12 of each column simultaneously. Each of the AND gates 12 of a column also receives one of the sequential bits bᵢ according to the selected manipulation. In the basic case of Galois field scaling, bits bᵢ are assigned to Galois field values such as those shown in FIG. 2a. For example, the Galois field value in the first row of the table of FIG. 2 is applied to the AND gates 12 of the column to the left in FIG. 1 while the values in the second through the thirty-second rows are applied in order to the AND gates 12 of the succeeding columns. In response to these values, each AND gate 12 furnishes an output value of ZERO if either of its input values is ZERO and an output value of ONE if both of its input values are ONE. Throughout this description, “ONE” and “1” are both used to describe a logical 1 value; and “ZERO” and “0” are both used to describe a logical 0 value. When so used for a bus of n elements, the implied logical value is understood to be repeated n times.

Thus, in a single operation, the results of the manipulation of the message bits by each of the Galois field values of FIG. 2a are available at the outputs of the AND gates 12 of the columns.

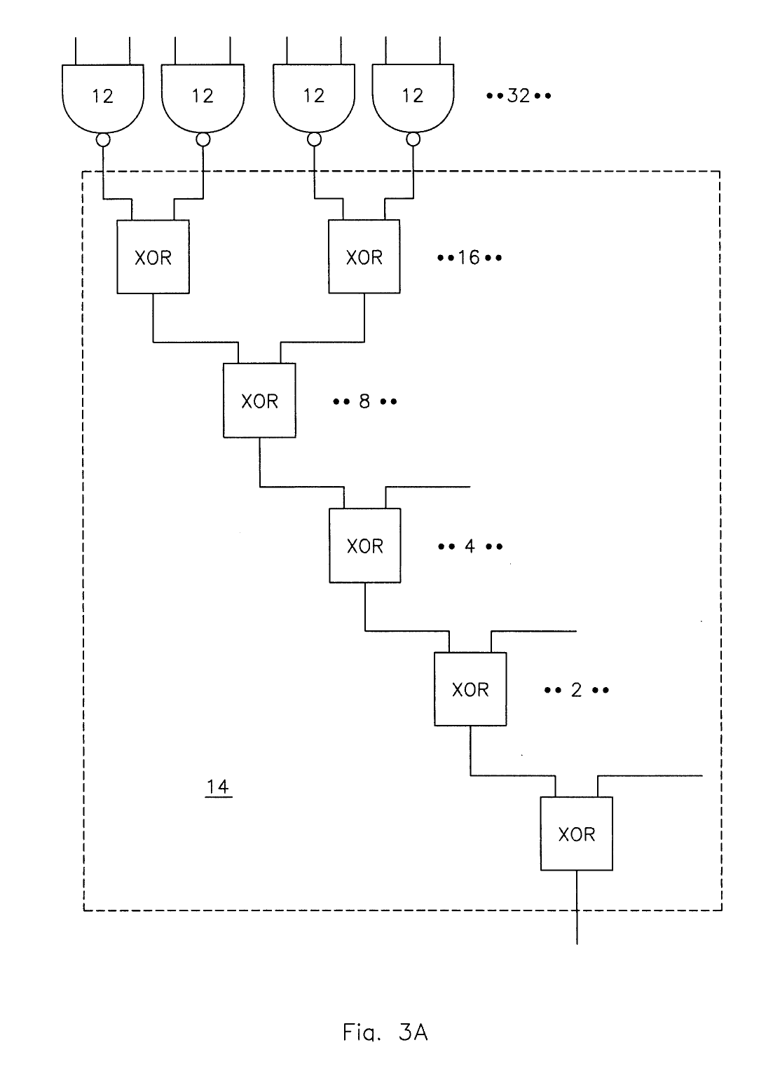

Associated with each logical column of the arithmetic unit 12 is a counting circuit comprising an exclusive OR (XOR) tree 14 (see the block diagram of FIG. 3A which describes a XOR tree for a thirty-two bit unit 10). Each XOR tree 14 receives all of the outputs of the AND gates 12 of the associated column and provides an output value which is the logical XOR of the values provided by all the AND gates 12 of the particular column. A XOR tree 14 is well known to those skilled in the art. In such an arrangement, the results provided by two adjacent AND gates in the column are first XORed together to provide an output value which is one if and only if a single one of its inputs is one. Then, this output value and the results of XORing the next two adjacent AND gates are furnished to XOR gates at the next level of the hierarchy and again XORed. The same operation is performed at the first level of the tree with the results provided by all pairs of adjacent AND gates. This tree arrangement effectively causes a bitwise XOR of the results produced by the AND gates of the column, a summing which continues until a single value is provided by a tree for each column of the arithmetic unit 10. This single result indicates whether the values produced by the AND gates 12 of that column are even or odd. Since an XOR tree essentially adds (or subtracts) in modulo 2 arithmetic the values provided, the results of each XOR tree is a one or a zero depending on whether the number of bits furnished to that XOR tree is odd or even, respectively.

Those skilled in the art will recognize that both the logical AND function and the logical XOR function may be performed by many different circuits. Apart from the specific devices of which a logic circuit is composed, different logical steps may be performed by stages of two different circuits which provide the same ultimate result. For example, both a basic AND circuit and a NAND circuit with an inverted output provide a logical AND function.

Moreover, the following properties based on De Morgan's law may be relied upon. First, an XOR circuit with both of its inputs inverted produces the same result as an XOR circuit that does not have its inputs inverted. As a result, the XOR of the output of two AND circuits produces the same result as the XOR of the output of two NAND circuits of the same input signals. Similarly, an XOR of the output of two XOR circuits produces the same result as an XOR of the output of two NOT-XOR (NXOR) circuits of the same input signals. Hence, AND gates followed by a binary XOR tree produce the same result as NAND gates followed by a binary XOR tree, and produce the inverted result of AND or NAND gates followed by a binary NXOR tree. Secondly, the OR function with its inputs inverted is equivalent to the NAND function of its inputs. Hence, an AND circuit followed by an OR function produces the same result as a NAND function followed by another NAND function.

In addition, when a plurality of stages of logical operations are involved in producing a particular logical result, various of the manipulations such as is inversions particular to a specific circuit may be included within others of the stages yet produce the same results. These characteristics are utilized in providing a number of advantages of the present invention. In order to facilitate an understanding of the different aspects of the invention, particular logical operations which result from a particular configuration of the circuits utilized are referred to as “logical functions” (e.g., the logical AND function, the logical OR function) no matter which specific circuit performs the function. Consequently, the scope of the invention should be considered to include the various different circuits which may be utilized to carry out the referenced logic functions.

FIG. 3B shows a reconfigurable arrangement 31 which can be utilized to perform the functions of an XOR tree (such as the tree 14 described above) as well as a number of additional functions described herein. The arrangement of FIG. 3B is an example of one embodiment of a tree which may be utilized with a small Reconfigurable Arithmetic Unit (referred to hereinafter as RAU) formed by an array of eight-by-eight AND gates. Sixteen of these smaller RAUs may be used to provide the same results as a single thirty-two by thirty-two RAU. A larger arrangement would be utilized for larger RAUs or portions thereof.

It should be noted that the particular arrangement illustrated in FIG. 3B receives inputs from the outputs of eight AND gates 12 and might therefore be utilized in an eight by eight RAU. Again, the number of rows in an exemplary RAU is based on the number of bits of a typical input message portion, while the number of columns is based on the largest order of the polynomial to be used in the cyclical redundancy check. The particular size selected is convenient for illustration purposes in that it may be utilized to is explain a number of the advanced operations of the invention without unnecessarily complicating the explanation. It should be noted that the particular arrangement illustrated in FIG. 3B may be reconfigured to accomplish a number of operations in addition to a basic cyclical redundancy check. For this purpose, the arrangement includes a number of component circuits which are capable of performing different logical functions when differently configured. The functions provided by these configurable component circuits allow the arrangement to accomplish the many additional operations which are explained in some detail later. For the basic arrangement, if all stages of the individual gates are configured for the tree to perform an overall XOR operation (by setting the select inputs to ZERO), then the tree functions as described above.

More particularly, the tree 31 illustrated in FIG. 3B includes to the left a first level of four similar logic circuits 32 each of which may be programmed to perform a NXOR function. NXOR circuitry is utilized rather than XOR circuitry because it is useful in implementing a number of additional functions (which are described below); however, the logical operations accomplished by the tree are the same (when appropriately configured) as the operations of the XOR tree 14 of FIG. 3A. These NXOR circuits 32 receive as inputs the inverted outputs produced by individual NAND gates in the column with which the tree is associated. That is, a RAU having eight rows provides inputs from the output of the logical AND gates of the first two rows which are inverted and furnished to the upper NXOR circuit in the entry level column, inputs from the output of the logical AND gates of the third and fourth rows which are inverted and furnished to the second NXOR circuit, inputs from the output of the logical AND gates of the fifth and sixth rows which are inverted and furnished to the third NXOR circuit, and inputs from the output of the logical AND gates of the last two rows which are inverted and furnished to the lower NXOR circuit. The outputs of the NXOR gates in the entry level (to the left) are provided as inputs to two NXOR circuits 32 of the next level, the outputs of the NXOR gates in the second level are provided as inputs to a NXOR circuit 32 of a third level (to the right), and the ultimate result is inverted by a circuit 34. Presuming that all of the select inputs to the circuits 32 are ZERO so that these circuits are configured to perform NXOR functions and the select input to the circuit 34 is ZERO so that the circuit 34 functions as an inverter, then an overall XOR tree function is performed by the arrangement of FIG. 3B.

This may be appreciated by considering the results at each stage of the tree. Presuming that the physical arrangement utilizes NAND gates to furnish the inputs a-h and that all of the SEL values are set to ZERO so that the circuits 32 function as NXOR gates and the circuit 34 as an inverter, then the outputs of the circuits 32 at the first stage of the tree are NXOR(a,b), NXOR(c,d), NXOR(e,f), NXOR(g,h). Then, the outputs of the circuits 32 at the second stage of the tree are NXOR (NXOR(a,b), NXOR(c,d)), and NXOR (NXOR(e,f), NXOR(g,h)). These values of outputs of the circuits 32 at the second stage reduce to NXOR (a,b,c,d) and NXOR (e,f,g,h). Then, the output at the third stage of the tree becomes NXOR (a,b,c,d,e,f,g,h). When inverted by the circuit 34, the result is XOR (a,b,c,d,e,f,g,h).

The truth table of FIG. 3B illustrates a number of different operations which may be performed by the tree 31 when different select inputs are provided to the tree. The upper row indicates those just discussed that cause the tree 31 to accomplish the XOR operation. The other operations which may be accomplished by the tree 31 are discussed at other places in this description.

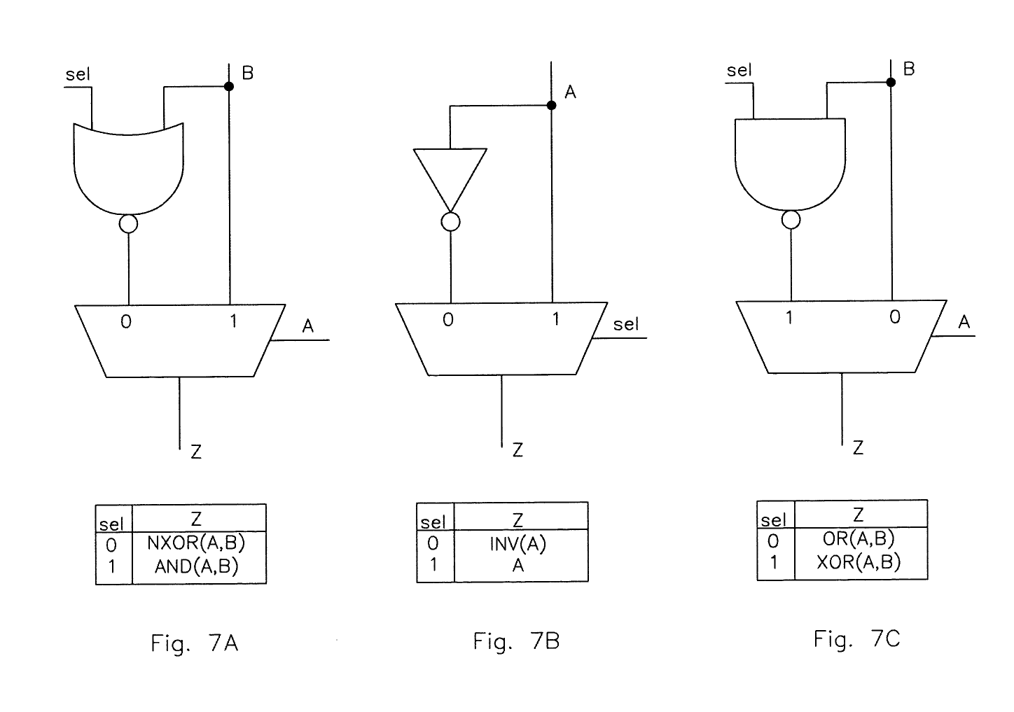

In order to allow the tree to perform the different operations, circuits 32 and 34 may be utilized such as those illustrated in FIGS. 7A and 7B which provide more than one logical function. More particularly, one embodiment of the circuit 32 may include a multiplexer the output of which is determined by a value A which may be considered to be a first of two input values. The particular value A chooses either an input value B (with a value of ONE on A) or the result furnished by a NOR gate (with a value of ZERO on A) which receives the value B and the SEL (select) setting referred to in the truth table of FIG. 3B. Since the output of a NOR gate is ONE only when both inputs are ZERO, the SEL setting of ONE assures that the output of the NOR gate will be a ZERO; this has the effect of causing the output of the multiplexer of the circuit 32 to be a ONE only if both A and B input values are ONE. As the truth table of FIG. 7A illustrates, this causes the circuit 32 to function as an AND gate when the SEL setting is chosen to be ONE.

On the other hand, when the SEL setting is chosen to be ZERO, the NOR gate functions to invert the input value B. This causes the multiplexer to furnish an output which is that of a NXOR circuit. Thus, depending on its particular configuration, the circuit 32 of FIG. 7A is capable of performing either an AND or a NXOR logical operation.

The circuit 34 which is the last stage of the tree of FIG. 3B may be implemented by an embodiment illustrated in FIG. 7B. The circuit 34 includes a multiplexer the output of which is chosen by a SEL (select) setting to be either an input value A or the inverse of that value. Thus, the circuit 34 is capable of performing either a logical inversion or of simply transferring its input to the output depending on its configuration. Other embodiments of the circuits of FIG. 7A and FIG. 7B for implementing the desired logic functions will be apparent to those skilled in the art. For example, if the NOR gate of the circuit of FIG. 7A is replaced by a NAND gate and the multiplexor inputs are switched to choose B when A is ZERO and the result from the NAND gate when A is ONE (see FIG. 7C), then the circuit may be configured by a SEL setting of ZERO to perform an OR operation and by a SEL setting of ONE to perform an XOR operation. Either of these functions may be utilized in to provide an XOR tree.

The results produced by the XOR trees 14 of FIG. 3A or 3B are furnished as sequential bit values for each column. By picking the parity mask bit values according to FIG. 2A, the resulting sequential values are equal to the remainder resulting from the division of the message value by the primitive polynomial for the particular thirty-two bit message portion. It should be noted that for CRC32, the parity bits furnished to individual eight-by-eight RAUs depend on the position in which the particular RAU resides in the thirty-two bit array pattern. And with these smaller RAUs, the four values provided from the trees 31 of the four RAUs for each column must be combined by higher level XOR gates to provide each column value. Thus, the arithmetic unit 10 may be caused to provide a remainder which may be either appended to a message for transmission or utilized to help determine if a received message has been accurately transmitted.

Using a plurality of reconfigurable arithmetic units allows longer messages to be handled in parallel. It has been shown in the Fast Parallel CRC Algorithm and Implementation on a Configurable Processor publication and in the discussion above regarding equation 5 that it is possible to divide messages longer than thirty-two bits into thirty-two bit segments and handle in parallel the processing of the cyclical redundancy check values for of those individual segments. The results of processing the individual segments may then be combined to provide a result for the entire message.

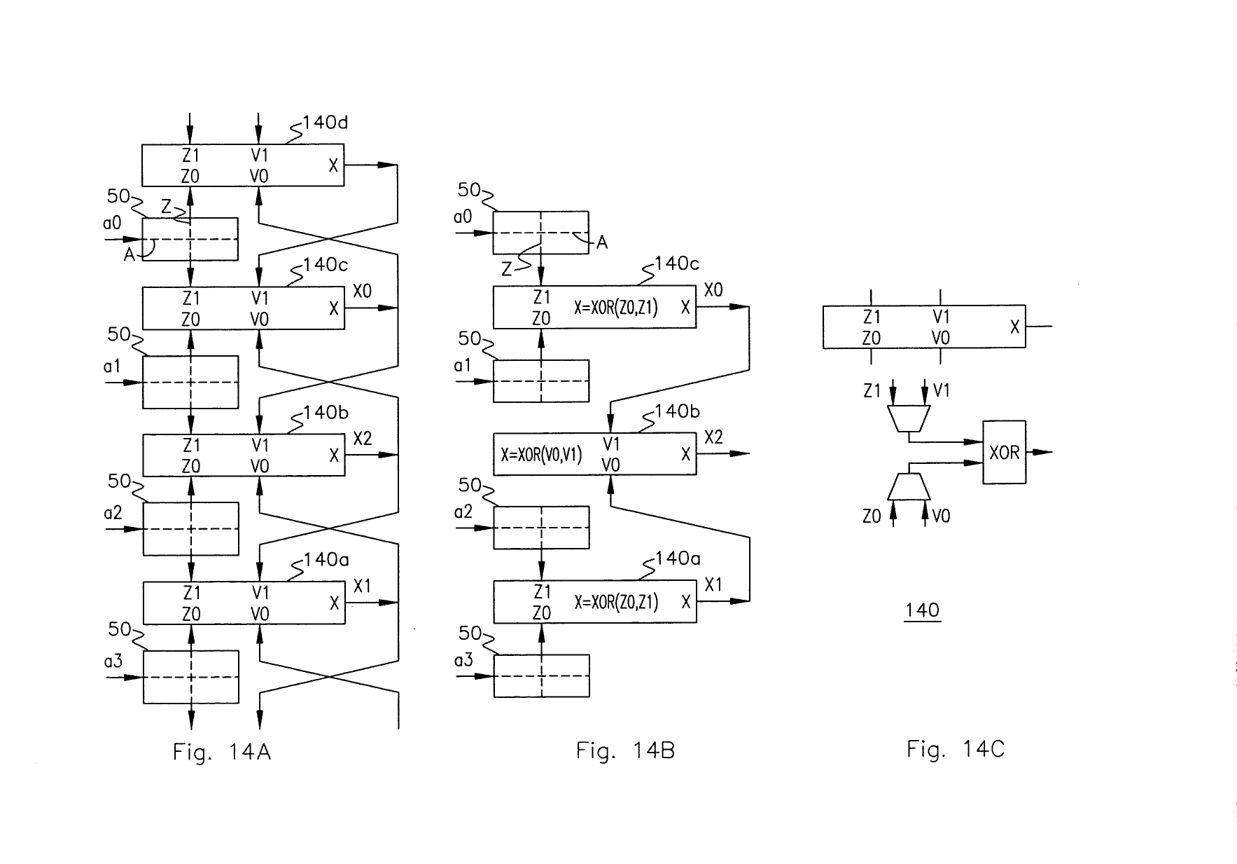

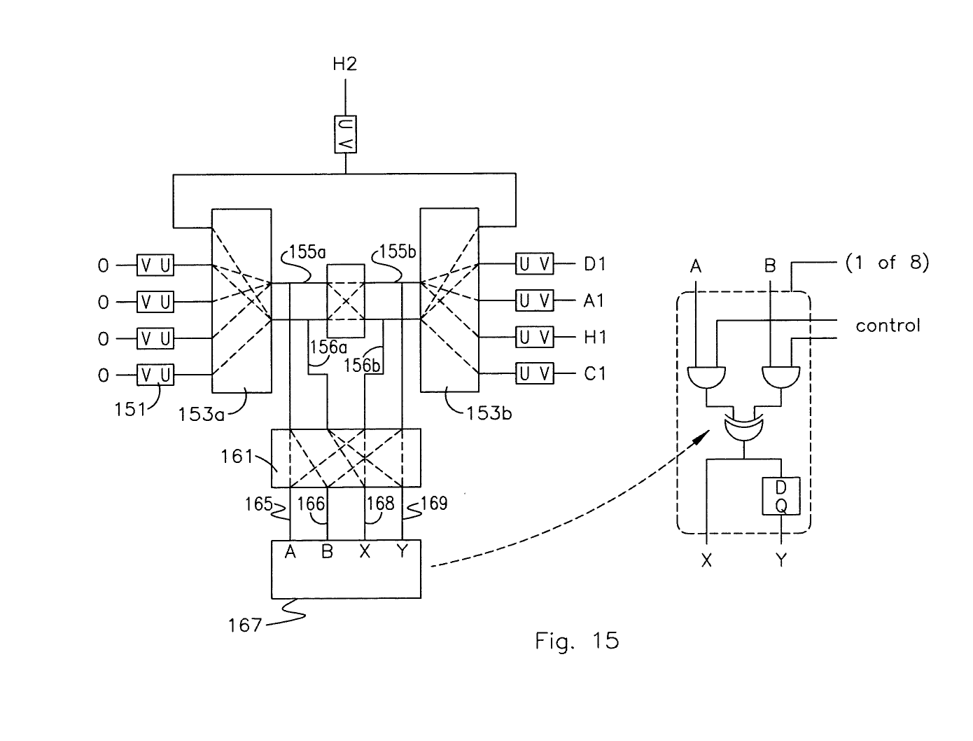

In one embodiment of the present invention (see FIGS. 14A, 14B, and 14C), larger messages are essentially broken into thirty-two bit portions and fed in parallel into a plurality of reconfigurable arithmetic units. For one hundred twenty-eight bits, four reconfigurable arithmetic units may be utilized to handle the portions of the message in parallel. The four individual RAUs are utilized to process individual ones of the cyclical redundancy check computations for four individual segments (bits 0-31, bits 32-63, bits 64-95, and bits 96-127) of a one hundred twenty-eight bit message. In such an arrangement, individual thirty-two bit segments are furnished in parallel to each of the four reconfigurable arithmetic units where each portion of the message is handled separately just as though the entire message were only thirty-two bits. The parity mask memories of each of the four RAUs are assigned different values precalculated from the different Galois field scaling constants corresponding to the section of the message they are processing, similar to the values shown in FIGS. 2A and 2B. The results of the four computations are then combined in a final XOR tree to produce the results of testing of the entire message. This may be accomplished conveniently by providing XOR gates to combine the results from adjacent reconfigurable arithmetic units and a final XOR gate for combining the results of these XOR gates together.

FIG. 14A shows an unconfigured structure containing four 32-bit RAU's 50, four vertical switchboxes 140a-d, four sets of 32-bit wide input buses a0-a3, and vertical 32-bit wide conductors between outputs Z of RAUs 50 and inputs Z0 and Z1 of adjacent vertical switchboxes 140, as well as between outputs X of vertical switchboxes 140 and inputs V0 and V1 of neighboring vertical switchboxes 140.

FIG. 14B shows portions of the same structure but configured to perform the CRC calculation on 128-bit message portions described above. The required functionality is achieved by setting switchboxes 140a and 140c to produce the XOR of their inputs Z0 and Z1 at their outputs X, while switchbox 140b is configured to produce the XOR of inputs V0 and V1 at its output X.

FIG. 14C shows an embodiment of vertical switchbox 140 that enables the required functionality. It consists of a 32-bit wide 2-input XOR gate, for which each input is connected to a 32-bit wide 2-input multiplexor for which the select can be configured to pick data from either X0 or Y0, or from X1 or Y1, respectively.

Similarly, larger messages may be handled in series of one hundred twenty-eight bit segments furnished to the four reconfigurable arithmetic units provided for handling one hundred twenty-eight bits; since the operation is modulo 2, the remainder values wrap into the larger messages in a similar way as suggested by equation 14 for the sixty-four bit case.

It should be noted that a practical arrangement for handling messages of varying lengths might include additional circuitry. For example, If the messages to be handled are guaranteed to be multiples of thirty-two bits, four RAUs and additional multiplexers permits the last message portion to be sent into any of four, three, two, or one RAU and padded with zeroes. For messages which are guaranteed to be a multiple of eight bits in length (the most common form in Ethernet communication), an additional fifth RAU and additional multiplexers may be used to perform a necessary length correction step that can also be reduced to a Galois field scaling step as known to those skilled in the art.

Moreover, a practical arrangement might include two complete sets of four (or five) reconfigurable arithmetic units in order to accomplish the processing of both incoming and outgoing messages.

Although the values used in the Galois field manipulation are usually well known and may therefore be precomputed, the basic arithmetic unit 10 of the present invention allows a number of variations. The arrangement utilizes programmable inputs to the AND gates 12 for values generated using the primitive polynomials. Because these values are programmable, the use of the circuitry may be changed from simply accomplishing the cyclical redundancy check utilizing a constant primitive polynomial to other uses. By utilizing AND gates 12 having a variable input B, a different value may be provided in place of a standard internet Galois field value. For example, if another polynomial is utilized in the cyclical redundancy check manipulation, then the Galois field value used at the receiver may be different than that which has been precomputed. In such a case, the Galois field polynomial must be transferred from the transmitting station to the receiving station in order to accomplish the cyclical redundancy check operations. With the AND gate parity masking bit input to the arithmetic unit 10 of the present invention, this operation is easily accomplished since the Galois field values utilized in the manipulation may be readily varied.

The ability to modify the parity bit input values may also be useful for other than the determination of cyclical redundancy check values. Thus, the arithmetic unit 10 may be utilized to generate hash values useful in various operations of the circuitry with which the arithmetic unit 10 is associated. (e.g., see A Performance Study of Hashing Functions for Hardware Applications, M. Ramakrishna, E. Fu, and E. Bahcekapili, Proc. 6^{th}. Int'l. Conf. Computing and Information, 1994, pp. 1621-36).

Another advantage of the invention is the ability to utilize primitive polynomials other than that for thirty-two bits in the computations. There are a number of additional cyclical redundancy check verifications having associated primitive polynomials which are utilized for other purposes. For example, there are also primitive polynomials which have been selected for cyclical redundancy check verifications for eight, ten, twelve, and sixteen bit messages. Because the B inputs of the AND gates 12 of the arithmetic unit 10 are changeable, the arrangement provides the ability to work with these additional cyclical redundancy check verifications in smaller portions of the AND-XOR array. For example, since the values furnished to the B inputs may be controlled, it is possible to utilize sixteen bit by sixteen bit portions of the array to test for other than internet cyclical redundancy check values. The same ability allows even smaller portions such as eight by eight bit portions of the arrays to be utilized for similar purposes.

More importantly, providing additional inputs to sub-portions of the AND gates allows the individual sub-portions of the array to be associated with one another in a manner that the parts may be made to cooperate to provide a whole that may be easily manipulated. For example, the array may be utilized in a manner that four individual sixteen by sixteen arrays are provided. By dividing the individual inputs of the message and the added inputs into sixteen bit sections, all of these arrays may be made to function so that they provide results based on individual sixteen bit inputs. Moreover, the outputs of these sub-arrays may be combined and utilized in a manner so that effectively four individual sixteen by sixteen operations are being conducted in parallel. Of course, the same in true of the smaller sub-arrays such as those of eight by eight bits as described above.

In order to obtain the aforementioned advantages, it is desirable to provide inputs to and take outputs from the individual sub-portions of the array. In order to accomplish this, it is useful to provide additional horizontal input buses to eight-by-eight and to sixteen-by-sixteen subsections of the reconfigurable arithmetic unit. These inputs may be made programmable so that individual eight-by-eight or sixteen-by-sixteen sub-sections may be utilized as well as the full thirty-two by thirty-two bit array. It should be noted that, assuming that the entire reconfigurable arithmetic unit is provided the XOR trees discussed above for each column, then these XOR trees will, in fact, function to provide the desired result without additional change.

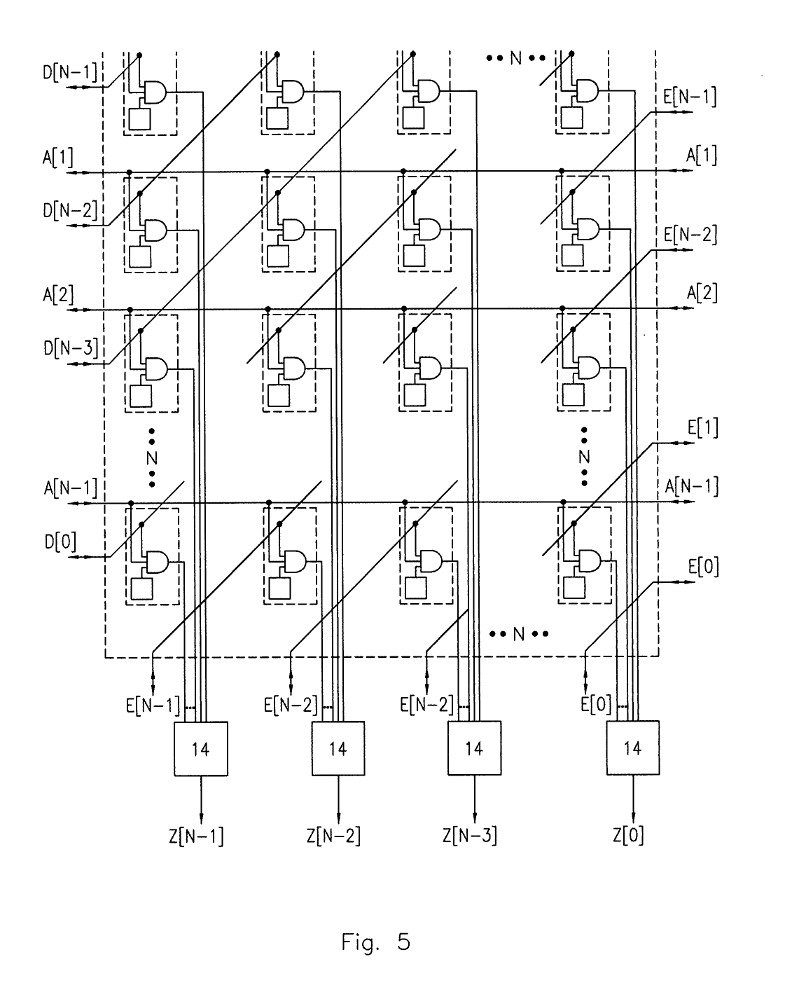

The operations which the invention may be utilized to accomplish are increased by the ability to utilize sub-portions of the thirty-two by thirty-two bit array or other convenient sized array and the enhancements illustrated in an embodiment of the invention shown in FIG. 5. In this embodiment, an additional set of inputs are provided for each AND gate associated with each column of the array. These additional inputs are connected diagonally, and allow the calculation of varieties of bitwise ANDs of different selected bits, similar to the partial product generation in regular arithmetic multipliers. Providing additional inputs allows easier control of the input values furnished to the AND gates by various switching arrangements so that real time changes to the input values are made very efficient.

The provision of the additional inputs to the AND gates also allows the reconfigurable arithmetic unit to be utilized for general Galois field multiplication.

General Galois field multiplication means the GF multiplication

A(x) B(x) mod G(x)

in which both operands A(x) and B(x) are variable, so that the method of precalculating a table that was presented for Galois field scaling does not apply. A typical application for this is in Reed-Solomon decoders [Blahut], and a typical implementation uses the extension Galois field GF(2⁸). For the following explanation, variables are elements of GF(2⁸) and a primitive polynomial of order eight, for example [Ref BBC Whitepaper WHP031, p. 8, Eq. 8]:

G(x)=x⁸+x⁴+x³+x²+x⁰ [Eq. M1]

In reference [Gill 1992], it is shown how a multiplication of two operands A(x) and B(x) may be accomplished in a two step process, consisting of first, the calculation of a raw product polynomial T(x) that is of degree-bound 16, followed by a scaling of the top portion of T(x) by a fixed value, and bit-wise XOR of that value with the lower portion of T(x). For completeness, that derivation is repeated in the following paragraphs.

Input operands and result in GF(2⁸) represented by the polynomials A(x), B(x) or the vectors A[7:0], B[7:0], and a result R(x) or R[7:0]:

First consider the raw multiplication result Prod(x) in polynomial form. This is a polynomial of order fourteen:

$$\begin{matrix}Prod ( x ) = {x}^{14} * ( A [ 7 ] * B [ 7 ] ) + \\ {x}^{13} * ( A [ 6 ] * B [ 7 ] + A [ 7 ] * B [ 6 ] ) + \\ {x}^{12} * ( A [ 5 ] * B [ 7 ] + A [ 6 ] * B [ 6 ] + A [ 7 ] * B [ 5 ] ) \\ … + \\ {x}^{8} * ( \begin{matrix}A [ 1 ] * B [ 7 ] + A [ 2 ] * B [ 6 ] … + \\ A [ 6 ] * B [ 2 ] + A [ 7 ] * B [ 1 ]\end{matrix} ) \\ {x}^{7} * ( \begin{matrix}A [ 0 ] * B [ 7 ] + A [ 1 ] * B [ 6 ] … + \\ A [ 6 ] * B [ 1 ] + A [ 7 ] * B [ 0 ]\end{matrix} ) \\ … + \\ {x}^{1} * ( A [ 0 ] * B [ 1 ] + A [ 1 ] * B [ 0 ] ) + \\ {x}^{0} * ( A [ 0 ] * B [ 0 ] )\end{matrix} \qquad [ Eq . M2 ]$$

Prod(x) is hence obtained by calculating the partial products for every combination of elements of A[0:7] and B[0:7], and performing a bit-wise XOR for partial products corresponding to equal powers of x.

This polynomial Prod(x) can be split in a lower half ProdLow(x), containing the coefficients corresponding to the powers (0 . . . 7) of x, and a higher half ProdHigh(x), containing the coefficients corresponding to the powers (8 . . . 14), but with x⁸ divided out so that:

Prod(x)=x⁸*ProdHigh(x)+ProdLow(x) [Eq. M3]

where:

$$\begin{matrix}\begin{matrix}ProdHigh ( x ) = {x}^{7} * ( 0 ) + \\ {x}^{6} * ( A [ 7 ] * B [ 7 ] ) + \\ {x}^{5} * ( A [ 6 ] * B [ 7 ] + A [ 7 ] * B [ 6 ] ) + \\ {x}^{4} * ( \begin{matrix}A [ 5 ] * B [ 7 ] + A [ 6 ] * \\ B [ 6 ] + A [ 7 ] * B [ 5 ]\end{matrix} ) … + \\ {x}^{0} * ( \begin{matrix}A [ 1 ] * B [ 7 ] + A [ 2 ] * B [ 6 ] … + \\ A [ 6 ] * B [ 2 ] + A [ 7 ] * B [ 1 ]\end{matrix} )\end{matrix} & [ Eq . M4 ] \\ \begin{matrix}ProdLow ( x ) = + \\ {x}^{7} * ( \begin{matrix}A [ 0 ] * B [ 7 ] + A [ 1 ] * \\ B [ 6 ] … + A [ 6 ] * \\ B [ 1 ] + A [ 7 ] * B [ 0 ]\end{matrix} ) … + \\ {x}^{1} * ( A [ 0 ] * B [ 1 ] + A [ 1 ] * B [ 0 ] ) + \\ {x}^{0} * ( A [ 0 ] * B [ 0 ] )\end{matrix} & [ Eq . M5 ]\end{matrix}$$

Note that here, the 8^{th} coefficient of ProdHigh(x) is always zero but it is added so that all buses used in the calculation can be multiples of eight bits.

The remainder of Prod(x) divided by G(x) is the desired result polynomial R(x). Since ProdLow(x) mod G(x)=ProdLow(x) and ProdHigh(x) mod G(x)=ProdHigh(x):

$$\begin{matrix}R ( x ) = Prod ( x ) mod G ( x ) \\ = ( {x}^{8} * ProdHigh ( x ) ) mod G ( x ) + ProdLow ( x ) \\ = ProdHigh [ 7 \text{:} 0 ] * T ( x ) + ProdLow ( x )\end{matrix} \qquad \begin{matrix}[ Eq . M6 ] \\ [ Eq . M7 ] \\ [ Eq . M8 ]\end{matrix}$$

Where:

T(x)=[x⁸ mod G(x), x⁹ modG(x), . . . , x¹⁴ mod G(x), x¹⁵ mod G(x))], [Eq. M9]

The coefficients of which can be precalculated since T(x) is independent of either operand.

Hence the coefficients R[7:0] of R(x) are obtained from:
(i) scaling of ProdHigh[7:0] by x⁸ mod G(x), which can be done using the precalculation technique described earlier;
(ii) bitwise XOR of the result of this scaling with the coefficients of ProdLow(x).

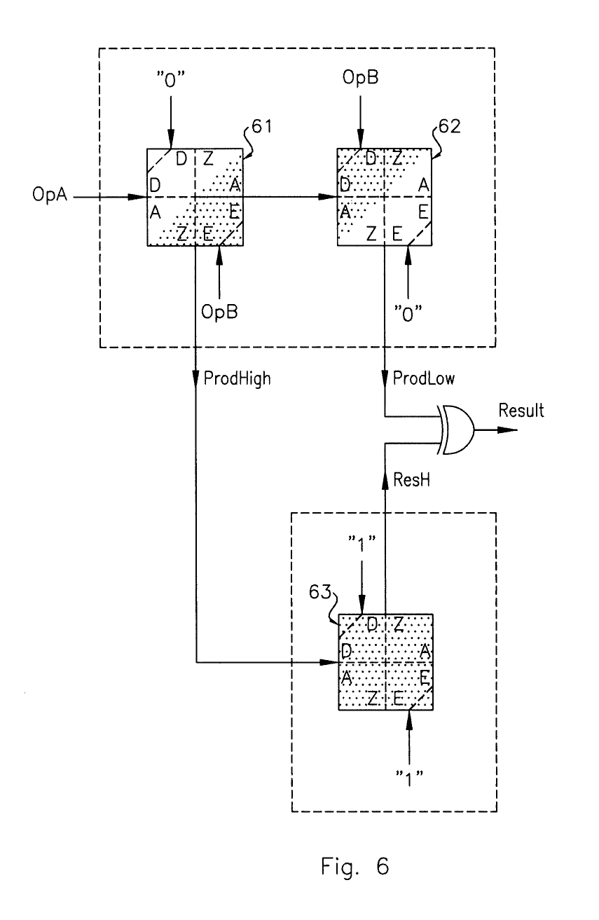

FIG. 6 shows how the invention can be used to obtain this result. Following the operations outlined by these equations, it will be assumed that the operation utilizes a Galois field (2⁸) defined by a primitive polynomial of order eight (hence eight bit operations) similar to what is commonly used in Reed-Solomon coding. In accordance with the mathematical explanation above, a general multiplication is split into two operations. The first operation produces a raw multiply result of fifteen positions in which the result is not yet reduced to a value in GF(2⁸). This is accomplished using two RAU portions. The second operation brings the polynomial result of the first operation which may be of an order up to fifteen bits back to GF(2⁸) by performing a Galois field scaling of the top seven bits of the raw multiply result and adding the result to the bottom eight bits. This is accomplished using a third RAU portion and a XOR gate.

FIG. 6 is an illustration of a process which maybe practiced using the array illustrated in FIG. 5. By furnishing one set of input values on the horizontal input lines to the array and the other on the diagonal input lines, it is possible to manipulate the array to accomplish the Galois field multiplication.

First, three sub-portions of the array 61, 62, and 63 are chosen to accomplish the operation. Each of these sub-portions may have an array size equal to the values to be utilized. That is, since values of eight bits are to be multiplied, the sub-portions of the array chosen are eight-by-eight in size. Typically a byte is the smallest useful segment of data which might be manipulated. Before input values are furnished to the array, inputs to certain of the AND gates in two of the sub-portions are rendered inoperative by zeroing the inputs provided on the diagonal input conductors. As may be seen in FIG. 6, the AND gates which are made inactive are those in the unshaded upper left-hand half of the sub-portion 61 and lower right-hand half of the sub-portions 62. This disabling operation may be accomplished by zeroing the parity masking bit inputs leading to the particular areas of the respective sub-portions to be disabled.

One of the values to be multiplied is furnished on the horizontal input lines to the two sub-portions 61 and 62 while the other value to be multiplied is furnished to the same sub-portions on the diagonal lines which are not furnishing disabling inputs. Thus all of the AND gates of all of the columns of the two sub-portions 61 and 62 receive the same input values on the horizontal lines; while, the value furnished on the diagonal lines increases by one bit weight with each column, proceeding from left to right. When the results produced by the AND gates are manipulated by the XOR trees of each column, a sixteen bit result consisting of a fifteen bit raw multiplication result padded in the most significand bit position by one 0 bit is provided by the two sub-portions.

To reduce this fifteen bit result to a GF (2**8) value, the high order bits provided as output by the XOR trees of sub-portion 61 are furnished on horizontal lines MpyH to the sub-portion 63. In sub-portion 63, these high order bits are scaled utilizing a matrix of values for a primitive polynomial for GF (2**8) Galois field operations. The results provided from the XOR trees of the columns of the sub-portion 63 are then combined (XORed) with the results provided from the XOR trees of the columns of the sub-portion 62 to provide a final result in GF (2**8) form.

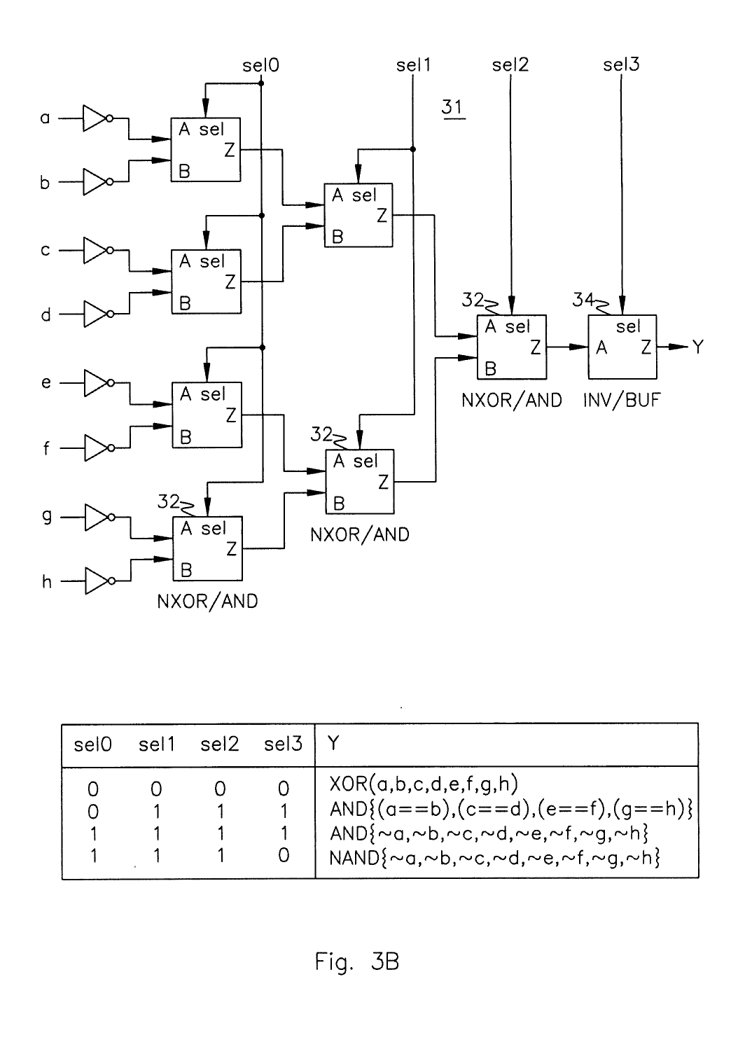

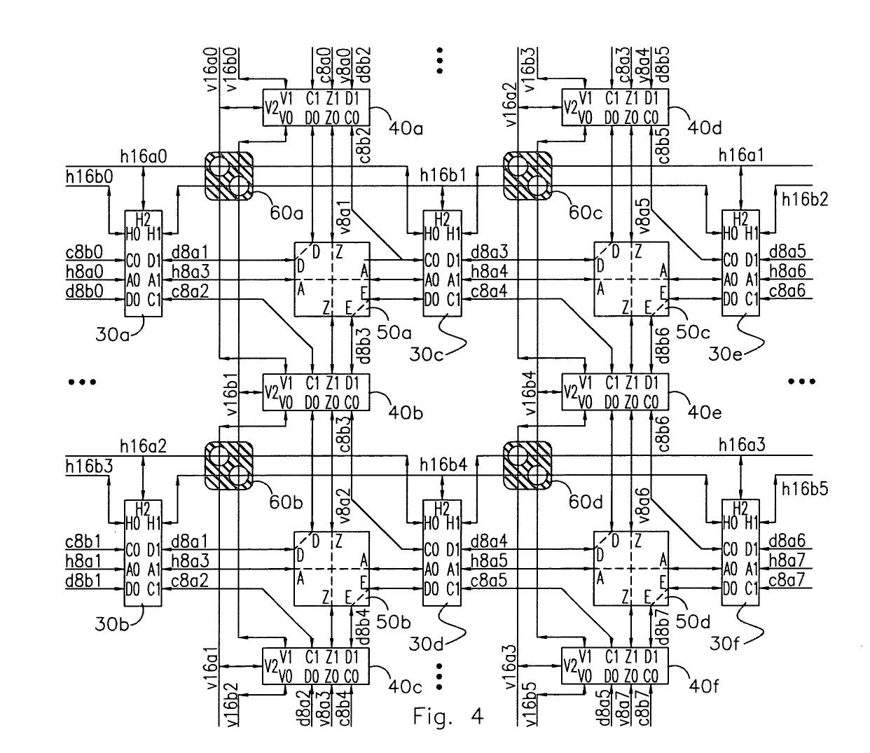

FIG. 4 is an illustration of one embodiment of circuitry which may be utilized to access and configure the operation of the RAUs of FIGS. 1 and 5. The circuitry illustrated includes four individual RAUs 50a-50d. The particular embodiment illustrated is designed to manipulate the more advanced RAU in a manner such as that illustrated in FIG. 5 and, consequently, includes circuitry for making available the advanced functions provided by that RAU as well as those of the RAU illustrated in FIG. 1. Other embodiments will be obvious to those skilled in the art upon obtaining an understanding of the circuitry of FIG. 4.

Each of the RAUs 50 illustrated in FIG. 4 is positioned to receive input from and provide output to two horizontally placed ones of a plurality of switch boxes 30. For example, the RAU 50a is positioned to receive input from and provide output to the two horizontally-placed switch boxes 30a and 30c. Similarly, the RAU 50d is positioned to receive input from and provide output to the two horizontally-placed switch boxes 30d and 30f. Each of the RAUs 50 is also positioned to receive input from and provide output to two vertically-placed ones of a plurality of switch boxes 40. For example, the RAU 50a is positioned to receive input from and provide output to the two vertically-placed switch boxes 40a and 40b.

In discussing the embodiment of FIG. 4, reference to values are used for a practical adaptation which is capable of providing the advantages of RAUs having both larger and smaller matrix sizes. In the discussion, each of the RAUs 50 is treated as an array of eight-by-eight AND gates. This particular size RAU is used for illustration purposes because it offers a convenient size into which a larger RAU may be subdivided for access purposes while still efficiently providing the functions of a thirty-two by thirty-two RAU discussed above. Only four of the sixteen smaller RAUs which make up a larger thirty-two by thirty-two AND gate matrix are illustrated so that the discussion can be limited to an understandable scope. Similar arrangements for providing access and manipulation of arrays of larger RAUs will be apparent to those skilled in the art.

The input signals available to each of the RAUs 50 include horizontal input values furnished on input buses prefaced by an “h” such as h8a2 furnished to RAU 50a. The nomenclature utilized indicates that the eight bit bus furnishes signals to a number of columns convenient to the particular size of the RAUs. Those buses including an “8” furnish signals across eight columns, while those including a “16” furnish signals across sixteen columns (across two RAUs). The latter buses are used to provide signals to two RAUs at the same time. The input signals available to each of the RAUs 50 also include two different values furnished on input buses connected to diagonal inputs of the RAU 50a. These are furnished on input buses prefaced by a “d” such as d8a0 and d8b3 which connect to the RAU 50a.

Output values are furnished by the RAUs 50 on buses prefaced by a “v” such as bus v8a1 joining RAU 50a.

Each of the horizontal switch boxes 30 receives input signals on three eight is bit input buses c8xx, h8xx, and d8xx and on one eight bit input bus h16xx which spans sixteen columns. Although not illustrated in order to reduce the complexity of this figure, particular embodiments may also include input buses which span thirty-two columns. Those skilled in the art will recognize that buses of other sizes also may be included depending on the particular use of the arrangement.

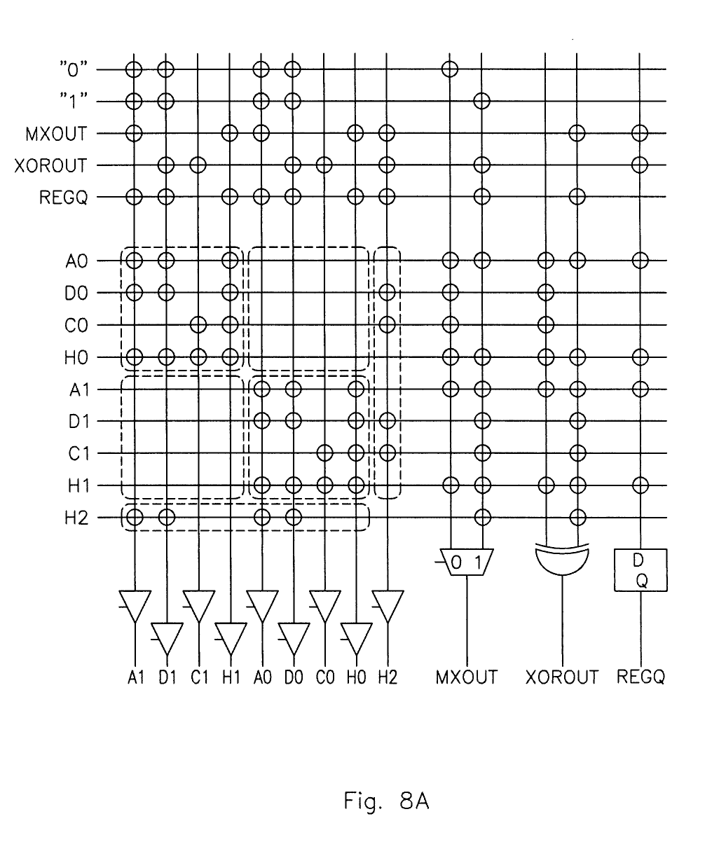

The internal elements of the switchboxes 30 and 40 may be similar so only a single switchbox is treated in detail. The manner in which signals may be provided to each of the RAUs from the horizontal and vertical switch boxes will be better understood by referring to FIG. 8A which illustrates one embodiment of a horizontal switch box 30 which may be utilized in practicing the present invention. An embodiment of a vertical switchbox 40 is illustrated in FIG. 8B. To the left in FIG. 8A are illustrated a number of inputs which may be provided to any of the switchboxes. These include inputs A₀, D₀, C₀, H₀, A₁, D₁, C₁, H₁, and H₂. Each of these individual inputs represents an eight bit bus carrying signals to the particular switchbox 30a. The inputs A₀, D₀, C₀, H₀ are provided at the left edge of the switchbox 30a, and the inputs A₁, D₁, C₁, H₁ are provided at the right edge of the switchbox 30a. The input H₂ is provided at the top of the switchbox 30a.

In FIG. 8A, each of the input buses is represented as a single horizontal path which crosses a number of vertical paths also representing eight bit buses. These vertical paths continue to outputs indicated at the bottom of the figure from the left as A₁, D₁, C₁, H₁, A₀, D₀, C₀, H₀, and H₂. Additional vertical paths continue also to outputs indicated as MXOUT, XOROUT, and REGQ. In the particular embodiment, a connection may be made between any of the horizontal input buses and the vertical buses at any point delineated by a circle. This arrangement allows any of the inputs to be connected to any of the outputs to which it is joined by a circle. Thus, for example, the input A₀ may connect to any of the outputs A₁, D₁, H₁, MXOUT, and REGQ but not, for example, to output XOROUT.

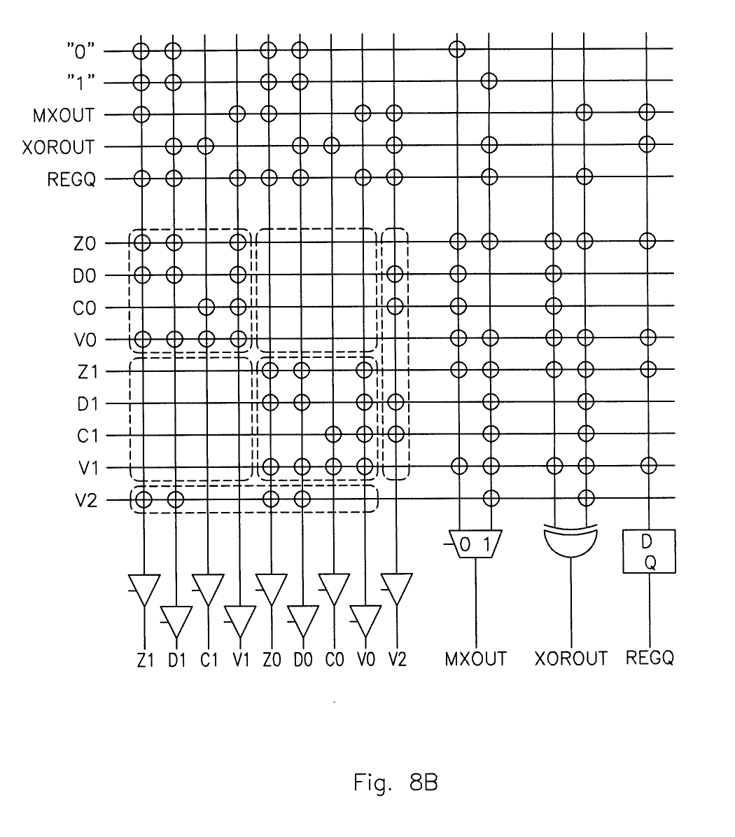

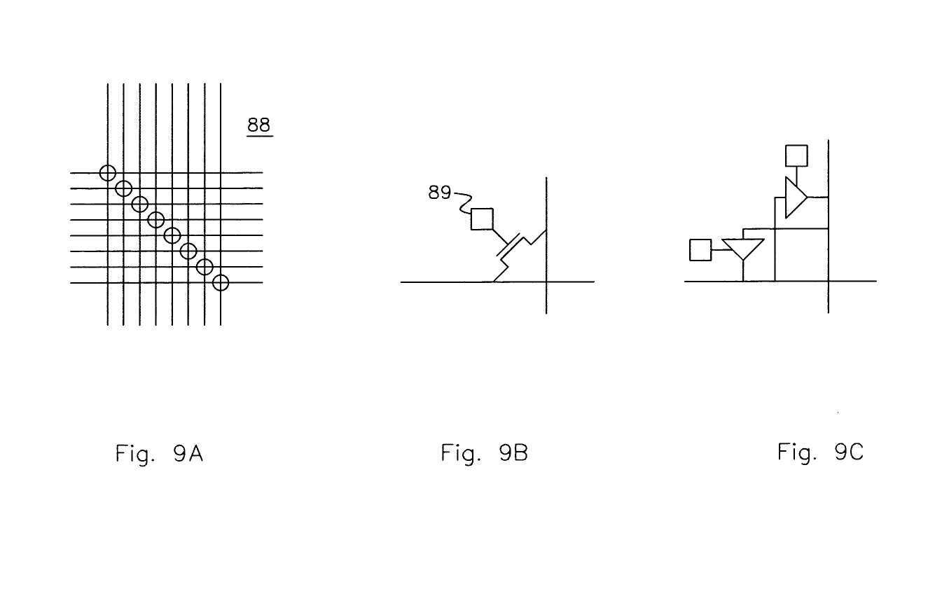

In addition, each of the circled intersections in FIGS. 8A and 8B represents a connection such as bus-wide switch 88 illustrated in FIG. 9A in which each of the eight bit buses may be connected to any of the other eight bit busses which it crosses using 8 individual switches 89 to allow byte shifting of values being transferred. FIG. 9B shows a bidirectional implementations of the individual switch 89 of FIG. 9B using a pass transistor switch with its gate controlled by a configuration memory circuit, and FIG. 9C shows a bidirectional implementation using cross-coupled tristate buffers with enables controlled by configuration memory circuits.

As may be seen, each of the outputs A₁, D₁, C₁, H₁, A₀, D₀, C₀, H₀, and H₂ is preceded by a tristate buffer. On the other hand, the output MXOUT is furnished by a multiplexer selecting from one of two vertical buses, the output XOROUT is furnished by a XOR circuit receiving inputs from two vertical buses, and the output REGQ is furnished by a DQ register receiving inputs from two vertical buses. Each of the MXOUT, XOROUT, and REGQ outputs is also furnished as an internally routed input on a similarly labeled horizontal bus. These horizontal buses allow connections to be made (at circled crossing points) to the various output channels.

In addition to the other inputs, logical ZERO (“0”) and ONE (“1”) values are furnished within the switchbox 30 so that these values may be furnished on the various outputs of the circuits. These are especially useful for setting the diagonal values of certain areas of the RAUs in order to allow the arrangement to be used for various arithmetic purposes such as Galois field multiplication previously discussed.

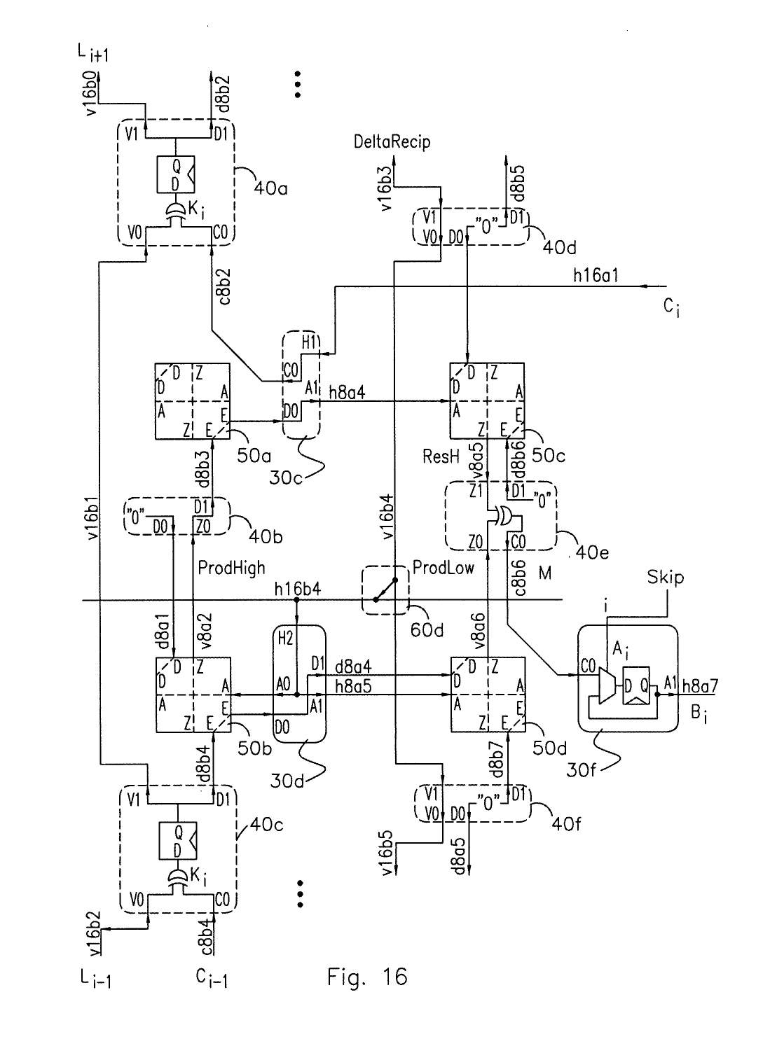

FIG. 15 is a block diagram illustrating another embodiment of a switchbox which is a “Clos-like” network (see Design of Interconnection Networks for Programmable Logic, by G. Lemieux and D. Lewis, Kluwer Academic Publishers, 2004, pages 11-12) that may be utilized in place of either the switchbox 30 or 40 in the architecture of FIG. 4. The values used in labeling the figure for illustration purposes are those for a horizontal switching arrangement as shown in the FIG. 4. Each of the signals is an 8-bit bus except where mentioned. The input signals furnished are directed through boxes 151 containing a “U V” designation to indicate that signals may be directed in either direction (for example, by cross-coupled tristate devices) to sparse crossbar 153 which allow the input signals D₀, A₀, H₀, C₀, and H₂ to be routed to one or both of two paths 155a or 156a and the signals D₁, A₁, H₁, C₁, and H₂ to be sent to one or both of the two paths 155b or 156b. In FIG. 15, the striped lines indicate the existence of a connection in the sparse crossbars. The paths 155 and 156 are also connected to switches which receive ZERO or ONE values (not shown). Those skilled in the art recognize that a sparse crossbar can be readily implemented using multiplexor circuits.

The paths 155 and 156 meet at another sparse crossbar 158 which provides for interchanging the signals on the two signal paths. The paths 155a or 156a also proceed by bidirectional paths 165 and 166 to a sparse crossbar 161 where the signals may be switched to the outputs A and B at a reconfigurable circuit 167. Bidirectional signal paths 168 and 169 return from the circuit 167 through the sparse crossbar 161 and to the paths 155b and 156b. The multiplexer 161 allows signals on paths 165, 166, 168, and 169 to be cross-coupled to the other paths.

At the circuit 167, signals on paths 165 and 166 are furnished to separate AND gates 163 and 164 where they may be transferred in response to control signals. It should be noted that each AND gate shown represents a bus width of individual AND gates controlled by a single input control. The AND gate outputs are furnished to XOR circuitry, and the result furnished to the signal paths 168 and 169. The circuit 167 has the ability to function as either a bussed multiplexer or a bussed XOR circuit and offers a bussed register at one output. As is illustrated, the signal paths 168 and 169 connect back to the sparse crossbar 161 where the signals may be rerouted through the arrangement. The circuit of FIG. 15 offers another arrangement for accomplishing the operations of the circuits such as those illustrated in FIGS. 8A and 8B.

In FIGS. 8A, 8B, and 15, any of the bidirectional paths with tristate buffers may be simplified to be a unidirectional path to obtain a speedier embodiment.

In order to illustrate the operation of the access circuitry shown in FIG. 4, a number of the functions of the RAU of the invention are considered. To assist in understanding these operations, various figures are included which describe mainly those elements of the circuitry which are utilized in the particular operation.

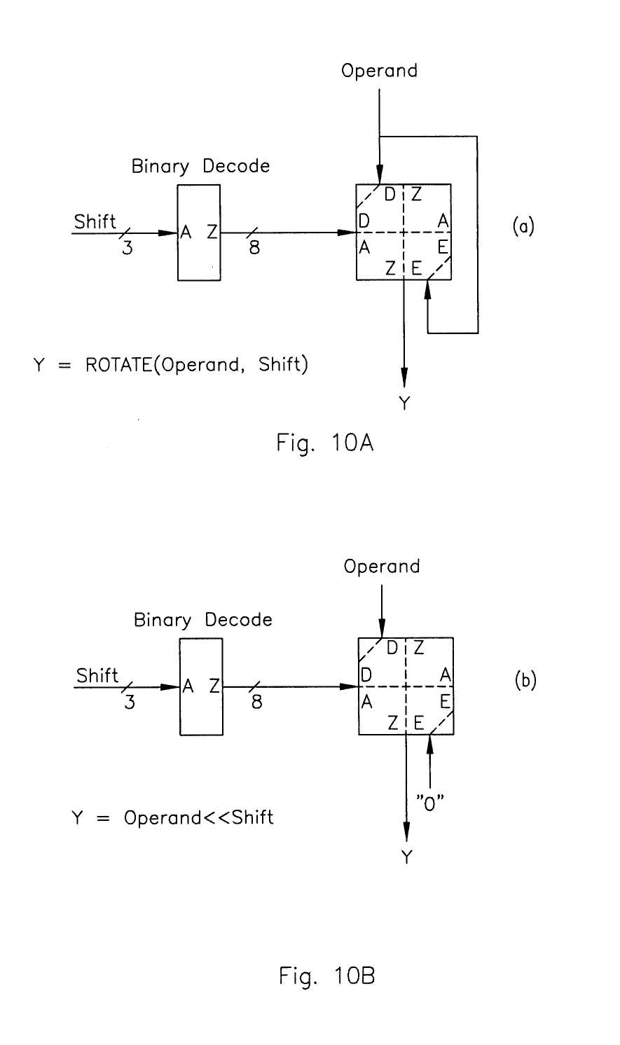

In particular, FIGS. 10A and B illustrate the use of one of the RAUs of the arrangement of FIG. 4 as either a rotator or a shifter. To accomplish this, a value to be shifted is furnished to the AND gates of the RAU on the diagonal input buses “d” and “e.” This causes the value to be available on each row of the RAU shifted one bit to the left with each descending row. A signal (a value of “ONE”) is provided on one of the input rows of the bus which selects the degree to which the value is shifted. To accomplish this, a three bit binary value is decoded and placed as a “ONE” on a single one of the eight bus lines for the horizontal input bus. This selects a single row by ANDing the values in only that row with the value being shifted. Since in FIG. 10A the value being shifted is placed on both the upper and lower diagonals of the RAU, the result is a value which is shifted by the desired number of places with the bits which have been shifted out at the high order end then replacing the zeroes at the low order bits by these shifted out bits, resulting in a rotation operation of the input bits. If instead the value being shifted is placed on only the upper half diagonal input bus and zeroes are provided to the lower half diagonal input bus, as in FIG. 10B, the high order bits which are shifted out are lost and the least significant positions are filled with zeroes. Ultimately, the shifted value is transferred to the output through the XOR tree arrangement; since a single row of the RAU carries a value, an XOR operation transfers this value directly to the output.

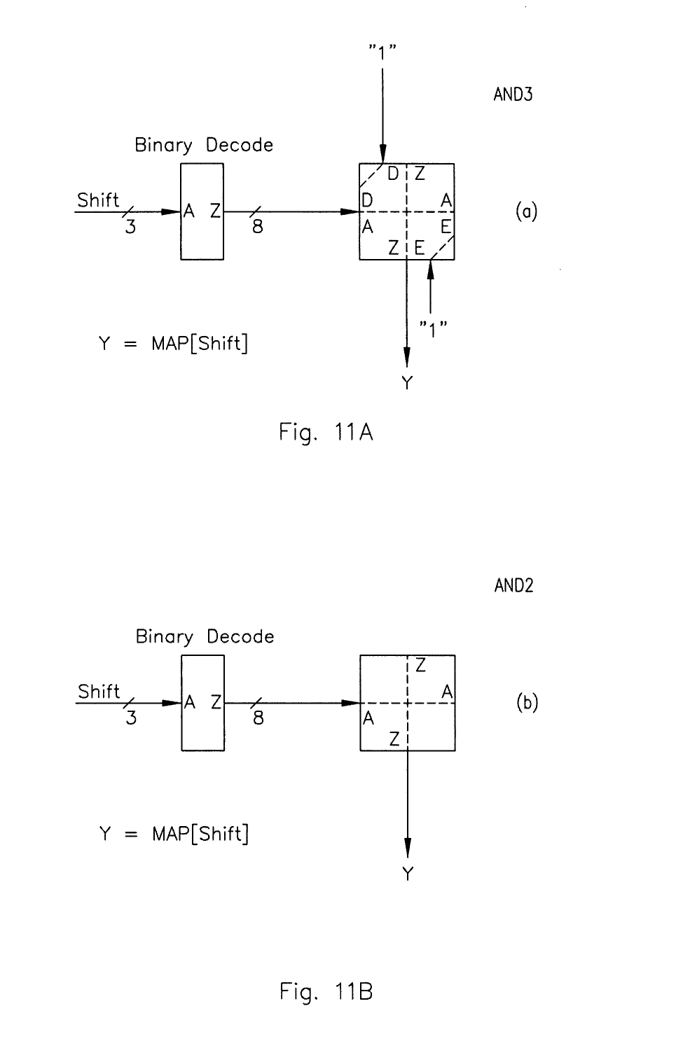

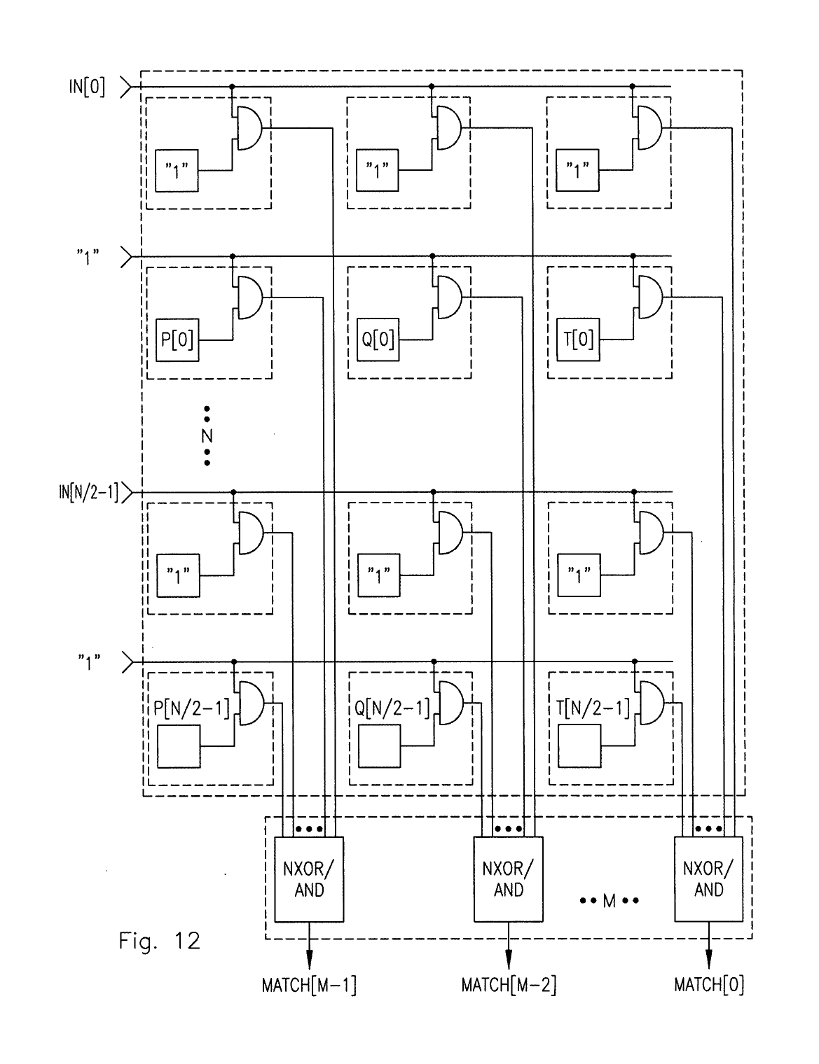

In a similar manner, FIGS. 11A and B illustrate the use of one of the RAUs of the arrangement of FIG. 4 as a look up table. FIG. 11A illustrates a RAU 50 utilizing an array of three-input AND gates. The values to be returned are stored in the parity memory array of the RAU so that the bits of the values provide one of the three inputs to the AND gates. Values of ONE are furnished to the lines of the upper and lower diagonal buses, and one of the horizontal lines of the horizontal input bus is selected by being furnished a ONE value. This causes the value stored in the parity memory of the array for the selected row (the row receiving a ONE) to appear at the output of each of the AND gates for that row. The results of the AND gates are provided to the XOR tree and combined. Since the XOR gates have all zeroes except for the value read out on the row selected by ONE, the result is identical to ORing the values.

FIG. 11B illustrates a look-up table arrangement in a RAU utilizing AND gates having only two inputs as in the arrangement of FIG. 1. In this case, the values being accessed are again stored in the parity memory cells of the array and read out by selection (a ONE furnished on a single horizontal line of the bus) of the particular row desired.

Another operation of the RAU is illustrated in FIG. 12. In this figure, values stored in the parity memory array for a particular row are accessed by content. Illustrated in FIG. 12 is a basic binary content addressable operation in which the values to be accessed are stored in alternating bits of the individual columns of the RAU separated by stored bits of one value. For example, the parity memory bits of the first, third, fifth, and seventh rows of the RAU store ONE; while the memory bits of the second, fourth, sixth, and eighth rows in each column store the bits of the value to be addressed in that column.

In order to access a particular value stored in the RAU, the value being sought is furnished on the first, third, fifth, and seventh rows of the horizontal input bus; while ONEs are furnished on the second, fourth, sixth, and eighth rows of the horizontal input bus. That is, the value being sought is furnished on alternate lines of the input bus at rows in which ONEs are stored by memory (i.e., IN[0], IN[N/2-1]). The other lines of the input bus are furnished values of ONE. This causes the AND gates of the particular column storing the value being sought to furnish an output indicating a match of the input value and the value stored by the column. Referring to the table of settings of the select values which may be utilized for programming the XOR tree of FIG. 3B, it will be seen that the second row describes convenient settings for those select values to provide an output indicating a match in a particular column.

The present invention may also be utilized to accomplish the functions of a programmable logic array (PLA). A PLA is a circuit which allows the implementation of arbitrary logic by mapping it onto two levels of logic, either (1) AND followed by OR or (2) OR followed by AND. The functionality of a PLA may be obtained by cascading two RAU circuits so that the output of the first RAU circuit is used as the input of the second RAU circuit. In the first RAU, the selection values of the counting tree (FIG. 3B) may be set to the values shown in line C of the truth table accompanying that figure. This results in the first RAU providing output values that are the result of NORIng selected input bits. In the second RAU, the selection values of the counting tree are then set to the values shown in line C of the truth table accompanying that figure. This results in eight functions that are the result of ANDing selected mixes of inverted bits.

A PLA-like structures of a higher number of logic levels can be obtained by cascading more than two RAU circuits in this manner.

A different type of PLA may be realized by using a function which XORs the sum of products. This may be implemented by configuring the counting tree of the second RAU circuit to provide XOR logic by setting the select values as delineated in line A of the accompanying truth table. Such an arrangement allows certain types of logic to be mapped more efficiently.

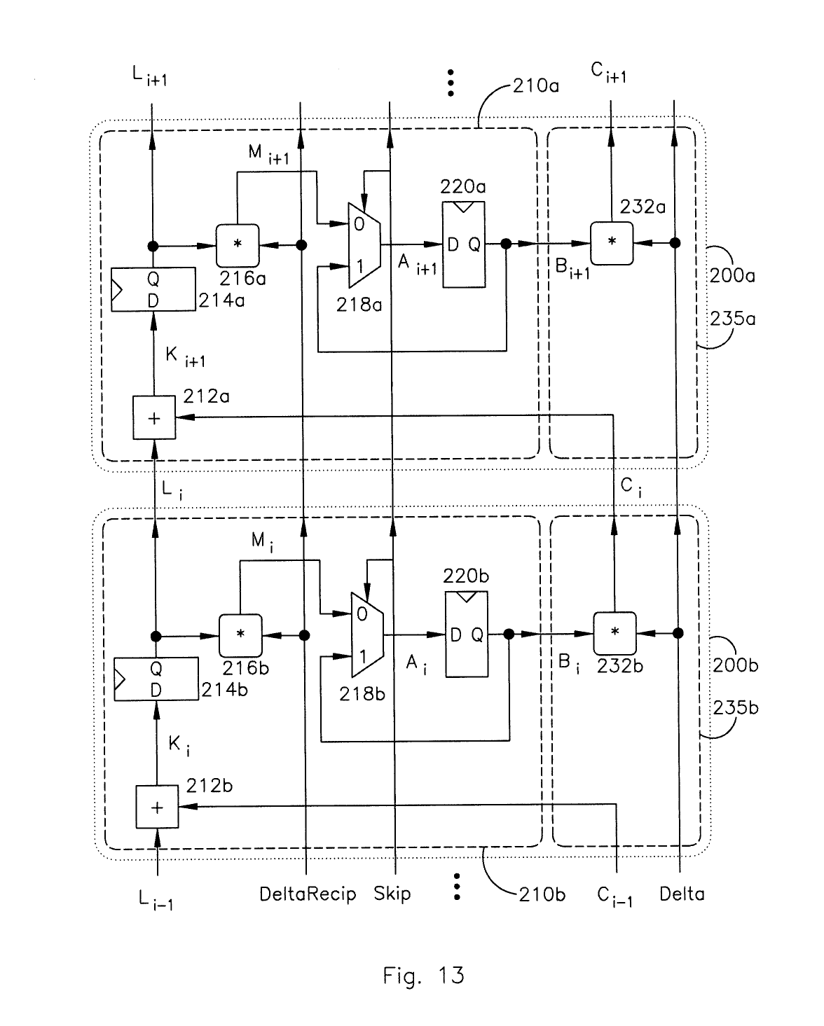

Another illustration will assist those skilled in the art to understand that much more sophisticated logical operations may be accomplished by the inventive arrangement utilizing the reconfigurable arithmetic units and the accompanying access circuitry shown in FIG. 4. To this end, reference is made to FIG. 13 which shows slices 200a and 200b, of a systolic array for the Berlekamp-Massey algorithm portion of a Reed-Solomon decoder, similar to the description in [Ref. Blahut], algorithm 7.2.1 (p. 185), included by reference.

It may be recognized that the following two equations are implemented in a repetitive manner for incrementing indices i−1,i,i+1 etc:

Lᵢ₊₁<=Lᵢ+Delta*Bᵢ [Eq. RS1]

Bᵢ<=Skip ? Bᵢ:Lᵢ*DeltaRecip [Eq. RS2]

where the variables Lᵢ₊₁, Lᵢ, Delta, Bᵢ, and DeltaRecip are elements of GF(2⁸) and “Skip” is a binary variable; “+” stands for addition in GF(2⁸), “*” stands for multiplication in GF(2⁸), “<=” denotes an assignment through a flip-flop or register on a predetermined clock edge, and the notation “A ? B:C” denotes a multiplexer that has output value B if A equals “1” and C if A equals “0”.

These equations can be divided into smaller portions, each corresponding to a specific hardware component shown in Figure [BKMSysArrayNew.ps], while keeping the same notation, as follows:

Lᵢ₊₁<=Kᵢ₊₁ [Eq. RS1a]

implemented in register 214a of section 210a,

Kᵢ₊₁=Lᵢ+Cᵢ₊₁ [Eq. RS1b]

implemented in Galois field adder 212a of section 210a,

Cᵢ=Bᵢ*Delta [Eq. RS1c]

implemented in Galois field multiplier 232b of section 235b, where Kᵢ₊₁, Cᵢ, and Cᵢ₊₁ are elements of GF(2⁸), and:

Bᵢ<=Aᵢ [Eq. RS2a]

implemented in register 220b of section 210b,

Aᵢ=skip ? Bᵢ:Mᵢ [Eq. RS2b]

implemented in multiplexer 218b of section 210b,

Mᵢ=Lᵢ*DeltaRecip [Eq. RS2c]

implemented in Galois field multiplier 216b of section 210b, where Aᵢ and Mᵢ are elements of GF(2⁸).

It may be recognized that the hardware described in FIG. 13 is of a repetitive nature, consistent with a systolic array, and that portions not explicitly described here operate in a similar manner as portions described above.

FIG. 16 shows how section 210b of slice 200b of the systolic array shown in FIG. 13 may be mapped onto the Galois field fabric of FIG. 4. When possible, the identifiers of FIG. 4 have been reused in FIG. 16 for those resources that are used, but logic functionality and connectivity may be detailed and the appearance may be different here. Those resources of FIG. 4 that are not shown in FIG. 16 are implicitly understood to be unused in FIG. 16. Similarly, wire stubs that are electrically connected but not functionally necessary are not drawn. Terminals of vertical and horizontal crossbar blocks that have been programmed as inputs or outputs are referred to as inputs or outputs. For clarity, some unused blocks of FIG. 4 that are necessary for this desription, may still be shown in FIG. 16 but are explicitly indicated as being unused. For clarity, connections set to logical “0” or “1” to inputs of unused RAU, that would remain necessary for electrical reasons, are not shown.

Except for the single bit signal “Skip”, all signals are sent on 8 bit buses representing elements of Galois field GF(2⁸). Vertical crossbar 40c of FIG. 16 is programmed to implement equations RS1a and RS1b, equivalent to register 214b and Galois field adder 212b of FIG. 13, respectively, and is programmed to have its inputs V0 and C0 act as inputs to the Galois field adder, and to have its outputs V1 and D1 both carry Lᵢ, the output of the register. Signal Lᵢ is routed on to the next slice of the systolic array on bus v16b1, and routed to to input E of RAU 50b on bus d8b4.

At this point, it is useful refer to the description of Galois field multiplier 216b of FIG. 13 which follows the implementation of the Galois field multiplier shown in FIG. 6. Horizontal crossbar 30d of FIG. 16 is programmed to copy signal L_i of its input D0 onto its output D1 and onto bus d8a4, which is connected to input D of RAU 50d.

Vertical crossbar 40b is programmed to furnish a logic “0” on its output D0, and onto bus d8a1, which is connected to input D of RAU 50b, and vertical crossbar 40f is programmed to furnish a logic “0” on its output D1, and onto bus d8b7, which is connected to input E of RAU 50d. Vertical crossbars 40d and 40f have been programmed to furnish the signal of their inputs V1 on their outputs V0, and externally supplied value DeltaRecip is distributed along buses v16b3, v16b4, and v16b5.

Cross switch 60d is programmed to connect bus v16b4 to bus h16b4. Horizontal crossbar 30d is programmed to furnish the signal of its input H2 onto is outputs A0 and A1. As a result, DeltaRecip is available on bus h8a3 and on input A of RAU 50b, as well as on bus h8a5 and on input A of RAU 50d.

Furthermore, RAUs 50b and 50d have been set to operate as Galois field multipliers, and produce the high and low portions ProdHigh and ProdLow of the raw multiply value of Lᵢ*DeltaRecip on their outputs z, respectively. Vertical crossbar 40b and horizontal crossbar 30c are programmed to conduct signal ProdHigh from v8a2 to d8b3 and from d8b3 to h8a4, respectively. In FIG. 16, RAU 50a is drawn, but only input wire “E” is used to conduct signal ProdHigh across RAU 50a. The output Z of RAU 50a is not used.

In another embodiment diagonal buses for routing purposes only could be present.

Vertical crossbars 40d are programmed to furnish a logic “0” on bus d8a3 to input D of RAU 50c, and vertical crossbar 40e is programmed to furnish a logic “0” on bus d8b6 to input E of RAU 50c. RAU 50c is programmed to implement the Galois field scaling of ProdHigh by x⁸ mod G(x) to obtain ResH, similar to Equation M3. Vertical crossbar 40e is further programmed to produce the Galois field addition (i.e. bitwise XOR) of signal ResH on bus v8a5 and signal ProdHigh on bus v8a6, and furnish the result Mᵢ on bus c8b6.

Horizontal crossbar 30f implements multiplexer 218b and register 220b of FIG. 13. In FIG. 16, signal Mᵢ is taken from bus c8b6 and signal Bᵢ is furnished onto bus h8a7.

Due to the repetitive nature of the implementation, some logic belonging to the next slice 200a of the systolic array is also included in this figure. In particular, vertical crossbars 40a and 40d of FIG. 16 are programmed in the same way as vertical crossbars 40b and 40f, respectively and their functionality can be readily deduced from the above explanation.

Although the present invention has been described in terms of a preferred embodiment, it will be appreciated that various modifications and alterations might be made by those skilled in the art without departing from the spirit and scope of the invention. The invention should therefore be measured in terms of the claims which follow.

What is claimed is:

1. A reconfigurable arithmetic circuit comprising a matrix and
a counting circuit;
said matrix including
a plurality of parity mask cells arranged in columns and rows, each parity mask cell including
a gate implementing a logical AND function of its inputs to provide an output,
and a memory cell connected to furnish input to said gate of the cell, and
a plurality of horizontal conductors each connected to furnish input to the gates of the parity mask cells of a row,
said counting circuit including
a plurality of reduction trees including at least some reconfigurable logic gates arranged one for each column of said matrix,
each reduction tree receiving as input output from the gate of the parity mask cells of its corresponding column of said matrix, and
each reconfigurable logic gate having one configuration state implementing a logical XOR function of its inputs and having at least one configuration state implementing a logical function different from XOR,
each reduction tree producing an output equal to the parity of its inputs when all reconfigurable logic gates are configured to implement a logical XOR function.

2. An architecture comprising
a plurality of reconfigurable arithmetic circuits each including
a matrix comprising
a plurality of parity mask cells arranged in columns and rows, each parity mask cell including
a gate implementing a logical AND function of its inputs to provide an output,
a memory cell connected to furnish input to said gate of the cell, and
a plurality of horizontal conductors each connected to furnish input to the gates of the parity mask cells of a row, and
a counting circuit comprising
a plurality of reduction trees including at least some logic gates implementing a logical XOR function of their inputs arranged one for each column of said matrix
each reduction tree receiving as input output from the gate of the parity mask cells of its corresponding column of said matrix, and
each reduction tree producing an output equal to the parity of its inputs; and,
a plurality of reduction tree combination circuits individually located between the reconfigurable arithmetic circuits, each of the reduction tree combination circuits comprising,
one gate implementing a logical function of its inputs for each column of the matrices;
first reconfigurable switches for connecting at least some outputs of the reconfigurable arithmetic circuits to inputs of the gates implementing a logical function in a corresponding column of the reduction tree combination circuit; and
second reconfigurable switches for connecting at least some of the outputs of the gates of other reduction tree combination circuits to inputs of the gates implementing a logical function in the corresponding column of said reduction tree combination circuits.

3. A reconfigurable arithmetic circuit comprising
a matrix including
a plurality of partial product mask cells arranged in rows and columns, where rows and columns have incrementing arithmetic weights assigned, each parity mask cell including
a gate implementing a logical AND function of its inputs to provide an output, and
a programmable memory cell connected to furnish input to the gate
a plurality of horizontally-oriented conductors each connected to furnish input to the gates of the partial product mask cells of a row, and
a plurality of diagonally-oriented conductors each connected to furnish input to the gates of the partial product mask cells along the diagonal of increasing arithmetic weight of rows and columns, and
a counting circuit
receiving inputs from the gates of the partial product mask cells of the matrix, and
furnishing outputs conforming to at least one predetermined function of its inputs.

4. The circuit of claim 3 in which the counting circuit comprises a tree of logical XOR circuits.

5. The circuit of claim 3 in which the counting circuit comprises a tree of reconfigurable circuits, said reconfigurable circuits providing one configuration state furnishing outputs representing the logical XOR of inputs.

6. An architecture comprising
a plurality of reconfigurable arithmetic circuits each comprising
a matrix including
a plurality of partial product mask cells arranged in rows and columns, where rows and columns have incrementing arithmetic weights assigned, each partial product mask cell including
a gate implementing a logical AND function of its inputs to provide an output, and
a programmable memory cell connected to furnish input to the gate, and
a plurality of horizontally oriented conductors each connected to furnish input to the gates of the partial product mask cells of a row, and
a plurality of diagonally oriented conductors each connected to furnish input to the gates of the partial product mask cells along the diagonal of increasing arithmetic weight of rows and columns, and
a counting circuit
receiving inputs from the gates of the partial product mask cells of the matrix, and
furnishing outputs conforming to at least one predetermined function of its inputs;
a plurality of reduction tree combination circuits individually located between the reconfigurable arithmetic circuits, each of the reduction tree combination circuits comprising
one gate implementing a logical function of its inputs for each column of the matrices;
first reconfigurable switches for connecting at least some outputs of the reconfigurable arithmetic circuits to inputs of the gates implementing a logical function in a corresponding column of the reduction tree combination circuit; and
second reconfigurable switches for connecting at least some of the outputs of the gates of other reduction tree combination circuits to inputs of the gates implementing a logical function in the corresponding column of said reduction tree combination circuits.
